(19) United States
(12) Patent Application Publication
(10) Pub. No.: US 2011/0161139 A1
(43) Pub. Date: Jun. 30, 2011

(54) Capability Accelerator

(75) Inventors: Mainak Maheshwari, NOIDA (IN); Priyanka Jaitly, Faridabad (IN); Neha Mathur, New Delhi (IN)

(73) Assignee: ACCENTURE GLOBAL SERVICES GMBH, Schaffhausen (CH)

(21) Appl. No.: 12/706,922

(22) Filed: Feb. 17, 2010

(30) Foreign Application Priority Data
Dec. 31, 2009 (IN) 3034/MUM/2009

(51) Int. Cl. G06Q 10/00

(52) U.S. Cl. 705/7.42; 705/326; 705/321

(57) ABSTRACT

An automated approach to defining the structure of an organization in terms of the desired skill sets associated with each organizational role, assessing each member of the organization according to demonstrated proficiency levels within each competency area associated with a given organizational role, and generating a gap report detailing discrepancies between desired proficiency levels and demonstrated proficiency levels of individual members of the organization. The approach can further include generating a plan based upon a comparison of the desired proficiency levels and the demonstrated proficiency levels and executing the plan.

### CROSS-REFERENCE TO RELATED APPLICATION

This application claims priority to Indian Patent Application No. 3034/MUM/2009, filed on Dec. 31, 2009, which is incorporated herein by reference.

### TECHNICAL FIELD

The present disclosure generally relates to automatic report generation.

### BACKGROUND

When a workplace staff department fails to meet a desired level of performance, it is frequently difficult to ascertain where the problem lies. Each member of the department has a specified role, and each role is associated with a collection of skills and responsibilities. Depending upon the role, a particular skill level may be desired. For example, a manager may be assumed to have a higher level of competency for a given skill than one of the staff members overseen by that manager.

When performance goals are not met, it may be left to the managerial hierarchy to determine how to improve group performance. Staff members in management positions, for example, may be requested to evaluate the productivity levels and capabilities of the department and, in some cases, to offer training sessions to the entire group.

### SUMMARY

The enhanced capability accelerator described by this specification provides a structured program to support a workplace staff transformation exercise, by identifying and enhancing individual and collective capabilities. For instance, according to one innovative aspect of the subject matter described in this specification, a competency mapping is developed for an organization, where the competency mapping identifies the various personnel roles required (or desired) in the organization, the competencies necessary (or desired) to perform each role, and the proficiency levels necessary (or desired) for each competency. The current or prospective employees of the organization are assessed to determine their actual proficiency levels for the required (or desired) competencies by their present or future role within the organization. For each assessed employee, gaps between their actual proficiency levels and the necessary (or desired) proficiency levels are identified, for example through a gap report, and addressed, for example by automatically scheduling training which is specific to a particular identified gap.

In general, another innovative aspect of the subject matter described in this specification may be embodied in methods that include the actions of generating a competency mapping for an organization, the competency mapping identifying one or more competencies required to perform a role in the organization and, for each competency, a desired proficiency level selected from among multiple proficiency levels defined for the competency, and performing a competency assessment on a subject, the competency assessment assessing the subject's actual proficiency level for each competency. The method also includes generating, by one or more processors, a gap report using the competency mapping and the competency assessment, the gap report identifying, for each competency, any discrepancy between the desired proficiency level and the subject's actual respective proficiency level. Other embodiments of this aspect include corresponding systems, apparatus, and computer programs, configured to perform the actions of the methods, encoded on computer storage devices.

These and other embodiments may each optionally include one or more of the following features. The method may also include generating a plan for reducing or eliminating the discrepancy based on the gap report, and implementing the plan. Implementing the plan may further include generating a message to inform the subject of an employment or training action which resulted based on the discrepancy. Generating the plan may further include accessing a catalog of training courses, and selecting a training course which is designed to address the discrepancy. Implementing the plan may further include scheduling the subject to attend the training course. Generating the plan may further include preparing a hiring or promotion recommendation, or generating a succession plan. The method may also include performing a competency re-assessment on the subject responsive to executing the plan.

In other examples, generating the competency mapping may further include accessing a database of competency mappings that have been previously generated for other organizations, receiving a user-input identification of one or more attributes of the organization, determining a similarity between the organization and one or more of the other organization based on comparing the attributes with stored attributes for the other organizations, and selecting, as the competency mapping, one of the competency mappings based on the similarity between the organization and the one or more other organizations. The attributes may specify a type, size, or level of maturity of the organization. The role may include prescribed or expected behaviors associated with a particular position or status in the organization, and each proficiency level may specify an extent to which the subject exhibits a respective competence. The multiple proficiency levels defined for the competency may include an awareness proficiency level, a functioning proficiency level, a skilled proficiency level, and an expert proficiency level.

In additional examples, the method may also include defining the role, defining each competency, and defining the multiple proficiency levels for each competency. Defining each competency may further include defining a competency name and a process indicator that best exhibits application of the competency in practice. The method may also include generating a visualization of the competency mapping and the competency assessment, where the visualization of the competency assessment may provide the subject's actual proficiency level for each competency, and the proficiency levels for each competency as assessed for other members of the organization. Performing the competency assessment on the subject may further include conducting an interview of the subject, testing the subject using a psychometric test, conducting a group discussion with the subject, role playing with the subject, or performing an on-line testing exercise with the subject. The gap report may identify competency gaps for the subject and for the organization. The method may also include generating an assessment results validation interface for allowing a manager of the subject to validate results of the competency assessment or to order re-assessment. The organization may be a human resources department.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

Referring now to the drawings, in which like reference numbers represent corresponding parts throughout:

FIG. 1 is a conceptual diagram of a system for assessing workplace staff competencies and generating a plan to meet desired proficiency levels;

FIG. 2 is an exemplary architecture for assessing workplace staff competencies and generating a plan to meet desired proficiency levels;

FIGS. 3 and 4 are flow charts illustrating method in accordance with various general implementations;

FIG. 5A is a process flow diagram illustrating exemplary steps taken in executing an assessment of workplace staff competencies and generating a plan to meet desired proficiency levels;

FIG. 5B is a process flow diagram illustrating an example end-to-end solution of the process flow of FIG. 5A applied in a human resource department context;

FIG. 6 is a phase execution flow diagram illustrating execution options for the process flow diagram of FIG. 5;

FIGS. 7A and 7B illustrate example role definitions;

FIGS. 8A and 8B illustrate example competency definitions;

FIG. 9 is a table illustrating an example skills matrix;

FIG. 10 depicts an example user interface for managing talent assessment surveys;

FIG. 11 depicts an example individual gap report;

FIG. 12 depicts an example employee score card;

FIG. 13 depicts an example personal development report, detailing the relative strengths of an employee based upon the results of a competency assessment process;

FIG. 14 is a table illustrating an example course outline;

FIG. 15 is a schematic diagram of an exemplary computer system.

### DETAILED DESCRIPTION

### Capability Accelerator Overview

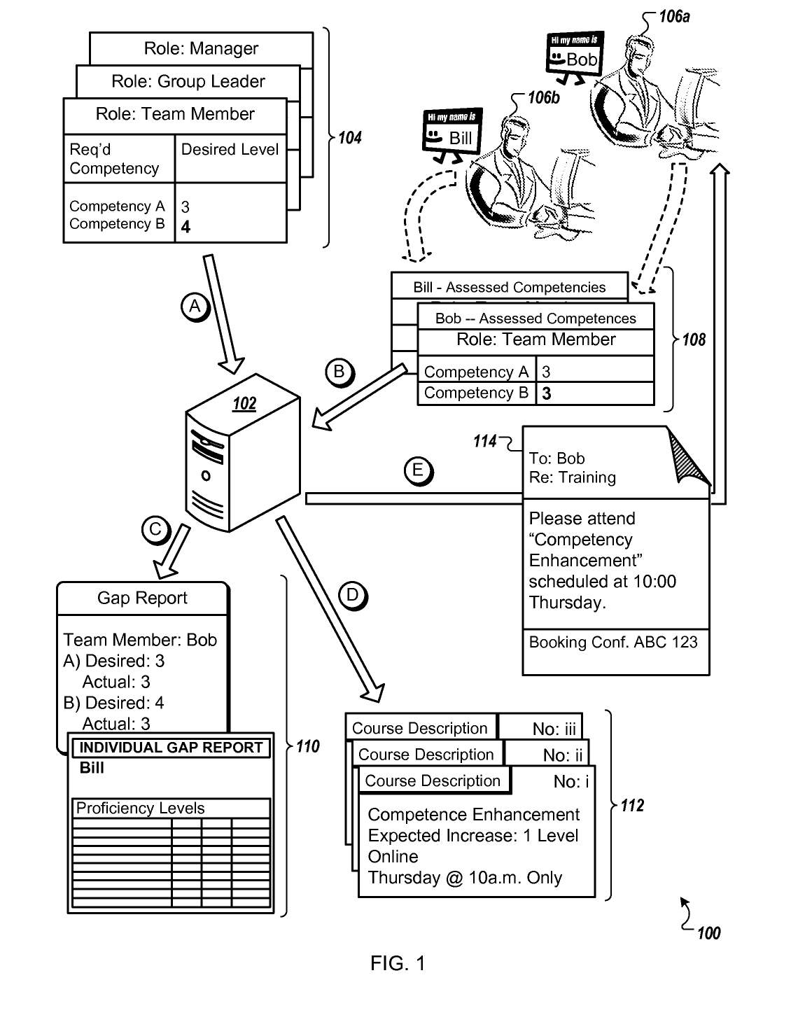

FIG. 1 is a conceptual diagram of a system 100 for assessing workplace staff competencies and generating a plan to meet desired proficiency levels. Through mapping desired proficiency levels and skill sets for each role within an organization, the capabilities of individual subjects can be assessed in comparison to these proficiency goals. When a discrepancy exists between the proficiency level of a subject and a desired proficiency level, a plan can be created to bridge the gap. As used herein, the term “subject” can refer to an employee, organizational team member, staff member, employment candidate, or other participant of a competency assessment process.

The process of assessing workplace staff competencies is automated through a computer server 102. Example steps within the process for assessing workplace staff competencies can include creating a set of role definitions 104, each role definition 104 associated with desired competencies demonstrated within a particular workforce staff position; performing an assessment of a set of subjects 106 based upon the desired competencies within each individual's current or potential role; generating assessment score cards 108 associated with each subject 106; producing a set of gap reports 110, each gap report 110 detailing the difference between exhibited competency levels and desired competency levels for the associated subject 106; recommending a training plan 112 for each subject 106 to increase proficiency levels within deficient competency areas; and implementing the training plan 112, for example by issuing one or more scheduling notifications 114 for conducting training sessions. Through execution of the process, the organization can increase overall productivity by selectively training, hiring, firing, or promoting individual members to better match individual employee skill levels to each job role.

The set of role definitions 104 can include lists of competencies associated with each role and a desired skill level associated with each competency, the desired skill level based upon the desired skills a productive employee exhibits within the particular role. Each role can correspond with a job title or organizational position within a work group. In some examples, role definitions 104 can include Human Resources Performance Management Lead, Human Resources Assistant Manager, or Human Resources Benefits Specialist. Each role can include a list of desired competencies and associated competency levels. The desired skill set for a Benefits Specialist, for example, can vary greatly from that of a Performance Management Lead while also sharing some core competencies. The skill level associated with each competency can vary as well from role to role within the organization. The role definitions 104 provide an overview of competencies, or skills, beneficial for performing specific roles within the organization.

The competencies within each role definition 104, in some examples, can include knowledge skills (e.g., software application proficiencies such as employee records system, understanding of state and federal regulations, etc.), performance skills (e.g., time management, documentation style, etc.), and interpersonal skills (e.g., motivational techniques, complaint management, etc.). Each competency is associated with a desired proficiency level. The proficiency levels can be defined as a scale ranging from novice to expert understanding of a given competency. In one example, a five level competency scale can be defined as “Novice”, “Experienced Beginner”, “Practitioner”, “Knowledgeable Practitioner”, and “Expert”.

Each proficiency level, in some implementations, includes a definition dependent upon the competency or set of competencies (e.g., performance skills vs. knowledge skills). In one example, when assessing interpersonal competencies, the competency scale can be defined as Novice: rule-based behavior, strongly limited and inflexible; Experienced Beginner: incorporates aspects of the situation; Practitioner: acting consciously from long term goals and plans; Knowledgeable Practitioner: sees the situation as a whole and acts from personal conviction; and Expert: has intuitive understanding of the situation and zooms in on the central aspects.

In some implementations, a library of sample role definitions can form the basis for the role definitions 104. For example, generic definitions for a human resources department can form the basis for constructing role definitions related to a particular human resource department within a given organization. The generic definitions can optionally include two or more sample competency mappings based upon various organizational attributes. The size of the organization, type of organization management (e.g., nonprofit, multinational, multi-site, etc.), or organization industry (e.g., engineering, legal, manufacturing, health services, etc.), in some examples, can each demand varying skill sets of a human resource department. The sample role definitions and competency mappings, in some examples, can be available through a table lookup or through an auto-population application based upon the input of one or more organizational attributes. Sample role definitions can then be customized to meet the needs of the individual organization. Because role names (job titles) can vary from organization to organization, the sample role definitions can optionally include descriptive information such as a role title, a role summary providing a natural language overview of the role, and a role description detailing the responsibilities associated with the role. In this manner, an organization can more easily match between sample role definitions and roles existing within the hierarchy of the individual organization.

A consultant, in some implementations can provide support to an organization during the process of establishing role definitions, competency descriptions, and proficiency level definitions. For example, the consultant can work with the organization to determine the strategic direction and goals of the organization, along with any future department-specific goals. The consultant can consider these goals when developing an initial list of competencies. The consultant then can work with the organization, for example, to map a list of roles and role descriptions to the hierarchy of the organization and to determine high level role descriptions. These roles, role descriptions, and competencies, for example, can then be used to generate the role definitions 104.

Once role definitions 104 associated with job positions within the organization have been established, the role definitions 104 are submitted to the computer server 102. The computer server 102 can additionally store proficiency level definitions and competency descriptions. The computer server 102, although pictured as a single unit, may include a networked system of multiple processing units. The computer server 102 can be accessed by the organization in a wired or wireless fashion through an intranet, extranet, local area network (LAN), wide area network (WAN), or Internet connection, in some examples.

In some implementations, access to the computer server 102 is provided to two or more organizations by a third party organization for the purpose of assessing workplace staff competencies. For example, an organization can review sample role definitions provided by the third party organization, customize those role definitions, and store the role definitions 104. The third party organization can then use the customized role definitions in assessing workplace staff.

The set of subjects 106 complete one or more assessment activities. Each assessment activity can correlate to one or more competencies associated with the role of each team member within a group, department, or organization or a new role for a candidate team member (e.g., promotion or employment opportunity). The assessment activities can include any number of physical or computer-based (e.g., online) exercises designed to determine a subject's proficiency level in one or more competencies, including those competencies associated with the subject's present or future role. In some examples, assessment activities can include multiple choice quizzes, essay questions, role playing, psychometric tests, interviews, group discussions, case studies, or one-to-one interaction with an evaluator.

The assessment activities can be performed at an Assessment Center. An Assessment Center employs a comprehensive standardized procedure in which multiple assessment techniques such as situational exercises and job simulation (e.g., business games, discussions, reports, and presentations) are used by multiple evaluators to assess subjects on multiple competency factors. In one example, the assessment activities conducted at an Assessment Center can be used to focus on the readiness of one or more team members for higher level roles in the organization by simulating real-life work challenges frequently encountered in these roles.

In another example, the assessment activities can focus on generating data on relevant competency strengths and gaps for career development and group improvement purposes. The Assessment Center can combine a mix of evidence-generating exercises and tools in a structured single day or multiple day experience to elicit competency data for each subject by creating a similar testing environment for each subject. In some implementations, multiple formally trained assessors engage in the assessment activities at the Assessment Center to observe critical behaviors, integrating and calibrating their observations to ensure an unbiased view of each subject.

In some implementations, individual competencies are tested through two or more assessment activities. For example, when testing for competencies A, B, and C, assessment activity (/) may primarily test for competency A with a secondary focus on competency B, while assessment activity (//) primarily tests for competency B with a secondary focus on competency C.

An example assessment process can include participating in a series of exercises simulating on-the-job situations and taking one or more tests which evaluate skills associated with a competency or competency cluster. During the assessment process, one or more assessors observe and document behaviors and skills displayed by each subject. If multiple assessors are on hand, an effort may be made to have each assessor observe each subject at least once. The assessors score each assessment activity and can optionally provide written comments regarding their observations. In the situation of multiple assessors, the observations and scores for each subject can be integrated through a calibration discussion process, in one example, before final ratings are recorded.

In some implementations, the assessment process is executed by a third party vendor based upon assessment criteria provided by the organization. For example, an assessment consultant can work with the organization to establish a competency assessment plan based upon a variety of considerations, such as the competencies which the organization would like to assess, a budget, timeframe, and the availability of the subjects being assessed. The assessment consultant can present example competency assessment plans including various options in styles of exercises. Once a competency assessment plan has been determined, the third party vendor can execute the competency assessment activities on behalf of the organization.

The assessment activities are scored to derive a skill level demonstrated by each subject 106 for each competency. For example, each assessment activity can be scored on the same proficiency level scale. Depending upon the type of assessment activity, the scoring can be automated or hand-graded. In some examples, the assessment activities can be individually graded or determined through an average score conducted by a panel. The competency scores for each subject 106 are compiled into the set of assessment score cards 108 which are stored within the server 102. The assessment score cards 108 can optionally include comments from one or more assessors regarding observations or an indication regarding actions the subjects 106 could have taken to improve one or more assessment scores.

The assessment score cards 108, in some implementations, may additionally be provided to the personnel responsible for conducting the assessment activities and/or the management chain of the individual subjects 106. For example, the server 102 could automatically email the assessment score cards 108 (e.g., in a HTML or XML file, word processing document, spreadsheet, or image including graph & text data) to the direct manager(s) of each subject 106. The manager(s) may optionally have the opportunity to validate the competency levels of their direct reports, adjust the levels, or order reassessments if the results do not match the manager's personal assessment of the subject's capabilities. Subjects 106 may also have the opportunity to receive a copy of their assessment score cards 108. For example, the assessment score cards 108 can be provided to the subjects 106 once they have been reviewed and adjusted by the direct managers, either through an automated process such as an email or during a one-on-one manager feedback discussion. In other implementations, the assessment cards 108 are stored as machine-readable data without printable formatting.

In some implementations, the server 102 generates the assessment score cards 108 based upon individual competency scores logged within the system. For example, one or more assessors can log into the server 102 to submit competency scores for individual subjects 106 based upon individual assessment activities. The server 102 may also be used to provide one or more assessment activities, such as online multiple choice quizzes, which are scored automatically by the server 102. The server 102 can additionally index or cross-reference the assessment score cards 108 based upon present or future roles of the subjects 106.

The server 102 generates the gap reports 110 based upon the data within the assessment score cards 108. The gap reports 110 identify differences between desired proficiency levels in key competencies, as specified within the role definitions 104, and actual proficiency levels in the competency areas. The gap reports 110 can be used to correlate identified deficiencies in competency areas with available training modules and suggest role-specific training options to close the gaps.

In some implementations, both individual reports and organization (e.g., team, group, department, etc.) reports are possible, including text or graphical data. The management hierarchy of the organization can receive differing versions of gap reports. For example, a direct manager may receive individual gap reports related to team members, while a higher manager may only receive group gap reports which identify key themes and areas for development.

The format of the gap reports 110, in some implementations, can be determined in part by the organization. For example, the server 102 can include one or more gap report templates. The organization can select between gap report templates based upon the style feedback desired. If a variety of groups, departments, or subjects within diverse organizational roles are being assessed, individual gap report styles can be selected based upon the role, group, or department of the individual subjects.

In some implementations, the assessment consultant, described above, can work with the organization to determine one or more customized gap report styles to meet with the expectations of the organization. For example, a gap report template can be modified to meet the needs of an individual organization, or a new gap report template can be generated by the assessment consultant.

In other implementations, the gap reports 110 include only machine-readable data without printable format for individual review. For example, the gap reports 110 can be used to generate the training plans 112 for individual subjects 106.

The training plans 112 are associated with the deficiencies identified through the gap reports 110. The training plans 112 include a listing of training options identified as being capable of improving a subject's proficiency in one or more competency areas so as to close the deficiency gaps identified within the gap reports 110. One or more courses can be included within each training plan 112. The server 102 can store a course library or remotely access a course library (e.g., through a network connection). The course library can include, in some examples, a list of available courses, including information regarding individual course descriptions, the course relevance to one or more competency areas, and the range over which the course is expected to improve the proficiency levels within the competency area(s), expressed in absolute or relative terms. For example, course (i) can be described as being expected to raise competency A by two proficiency levels, while course (ii) can be described as expected to raise competency B from proficiency level 3 to proficiency level 4.

Depending upon the breadth of the course library, two or more courses may be available which can be taken to improve the identified competency deficiency. In this case, the training plans 112 may include multiple options for fulfilling training needs. The manager of the team member, for example, can be provided the opportunity to select between training options. In another example, the server 102 can select between two or more available courses based upon one or more factors such as, for example, the cost of each available course, the immediacy of each available course (e.g., two days from now vs. two weeks from now), the location of each available course (e.g., online vs. a few hours drive away), the time requirements of each available course, or the relevancy of each available course to other deficiencies referred to within the gap reports 110.

In some implementations, a training consultant employed by a third party vendor works with the organization to design and tailor curriculum based on the competency gaps identified. The consultant can guide the organization through selecting delivery channels to use to impart training at different levels and skills sets. For example, the consultant can draft a list of training requirements, work with the organization to design and develop role-specific curricula, and match the detailed training objectives with a detailed course design.

Once the training plans 112 have been established, the subjects 106 are provided with scheduling notifications 114 regarding the scheduled training. The scheduling notifications, in some examples, can be distributed automatically through email from the server 102 to each subject 106 or personally provided by managers, human resource team leaders, or career development specialists.

Although the process has been described in relation to training plans 112 and scheduling notifications 114, in some implementations, the gap reports 110 can be analyzed automatically by the server 102 or individually by organization management to make recommendations in hiring, firing, or promotion decisions. For example, the gap reports 110 could be analyzed by the server 102 to rank candidates for a position by the closest fit between candidates and the position requirements as described by the role definitions 104. A suggested organizational chart, in another example, could be generated by the server 102 through analysis of the gap reports 110 for fitting an acquired organization into the parent organization.

Upon completion of the training, reassessments can be conducted, for example to verify the effectiveness of the training programs and to modify course offerings if needed. Reassessments may continually be made, for example on a scheduled basis, to continuously develop individual and collective skills, knowledge and behaviors to expand the organization's capabilities and strategic advantage. The reassessments can be part of ongoing talent development, aligning present and future staff with the growing needs of the organization and of the individual team members.

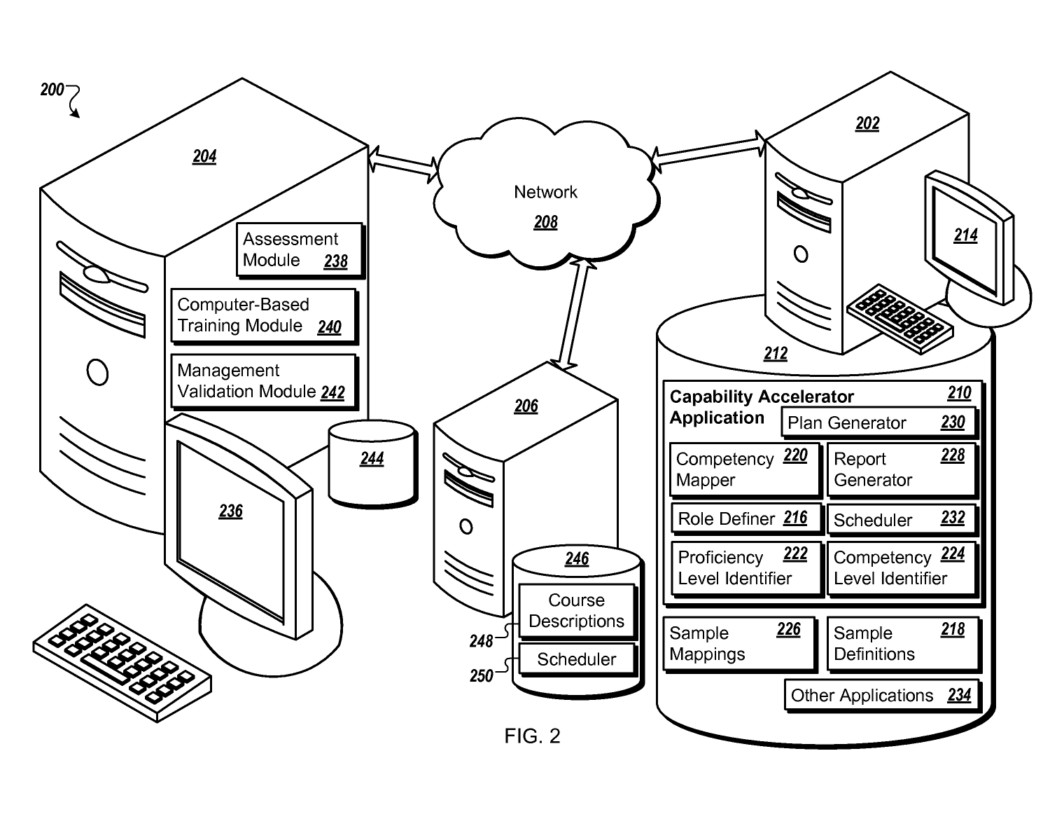

FIG. 2 is an exemplary architecture 200 for assessing workplace staff competencies and generating a plan to meet desired proficiency levels. The architecture 200, for example, can be used in executing the process steps of creating role definitions 104, assessing subject competencies based upon position role definitions and generating assessment score cards 108, calculating gap reports 110 based upon the assessment score cards 108, determining training plans 112 for subjects 106 based upon the gap reports 110, and scheduling training sessions through scheduling notifications 114 as described in relation to FIG. 1. The architecture 200 includes a server 202 (e.g., such as the server 102) capable of generating, in some examples, the role definitions 104, gap reports 110, and training plans 112; a client device 204, capable of conducting one or more capability assessment exercises and training exercises; and a third party server 206, storing organization-specific information such as training course descriptions and schedules. The server 202, client device 204, and third party server 206 are connected through a network 208.

The server 202 can be accessed through the network 208 or through a local user interface 214. The server 202 includes a capability accelerator application 210 within a storage medium 212. The capability accelerator application 210 is illustrated as a collection of individual modules for providing the framework to execute a staff competency assessment.

The capability accelerator application 210 includes a role definer 216 for creating the role definitions 104 (as described in FIG. 1). The role definer 216, in some implementations, can access a set of sample definitions 218 to form a basis when defining roles for a specific organization. The sample definitions 218, for example, can be customized as needed to meet the individual circumstances of an organization.

In coordination with the role definer 216, a competency mapper 220 can be used to associate one or more desired competencies with each defined role. In some implementations, a set of sample mappings 226 can be used to map competencies to role definitions. Customized competencies can be created as well. The sample role definitions 218, in some implementations, can each be associated with one or more sample competency mappings 226. If more than one sample competency mappings 226 are associated with a particular sample role definition 218, a user may be given a set of organizational attributes to select between sample competency mappings 226. These organizational attributes can be used to locate the closest match between the organization and sample role definitions created for other organizations. For example, in an organization with fewer than six hundred employees, mapping (a) may be more appropriate than mapping (b) which is geared towards a large organization.

Once the role definer 216 has generated one or more role definitions containing one or more competencies, a competency level identifier 224 can be used to define proficiency levels for each competency within each role definition 104. For example, within role definition (X), competency A can be assigned a proficiency level of 3 and competency B can be assigned a proficiency level of 4. The assigned proficiency levels define the minimum level of proficiency needed for a subject to perform the role defined within the role definition.

In some implementations, a proficiency level identifier 222 can be used to define a proficiency scale to be used when assigning competency levels. Depending upon the organization, customized level definitions can be created either on a global basis or focused per competency area or competency grouping. For example, a different proficiency scale can be used to define levels of proficiency in office management skills than may be used to grade interpersonal communication skills. The storage medium 212, in some implementations, can contain sample proficiency scales to be used as a basis for identifying proficiency levels per competency area. A proficiency scale, for example, can include a zero to n or one to n grading scale (n being any positive integer), with a definition assigned to each grade within the scale to describe the level of competency associated with the grade (e.g., low/medium/high, some familiarity/proficient/expert, etc.).

Once the role definer 216, the competency mapper 220, the proficiency level identifier 222, and the competency level identifier 224 have been used to create a set of role definitions populated with competencies and desired proficiency levels per competency, one or more subjects can participate in one or more assessment activities to be graded within the competency areas defined within their job roles or within a role definition associated with a potential future role. Based upon assessment results obtained through grading the assessment activities, a gap report generator 228 can generate one or more gap reports such as the gap reports 110 as described in relation to FIG. 1. The gap report generator 228, in some implementations, generates text and graphic based gap reports to provide to the subjects or organizational management. In other implementations, the gap report generator 228 generates machine-readable data regarding the difference between the proficiency levels associated with the role definitions and the proficiency level scores assigned to the subjects via the competency assessment activities.

The information obtained through the gap report generator 228 can be provided to a plan generator 230 to generate personalized training plans for each assessed subject, such as the training plans 112 described in relation to FIG. 1. The training plans are designed with the goal to improve any deficient competency areas. The training plans created by the plan generator 230 can include a listing of courses and course descriptions recommended to close the competency gap(s). If more than one course is identified relating to the same deficiency gap, in some implementations, the plan generator 230 can automatically choose between the courses based upon predefined priorities. For example, the plan generator 230 may select a course which is less expensive or shorter in duration than other available courses. In other implementations, the tentative training plan can be provided to organization management to finalize course selections.

A scheduler 232 can access the finalized training plans created by the plan generator 230 (e.g., as stored within the storage medium 212 or another local or networked storage medium) to devise personalized training schedules for each subject involved within the assessment process and issue scheduling notifications. In one example, the scheduler 232 can automatically generate email notification(s) such as the scheduling notifications 114 as described in FIG. 1. The training notification(s) can be issued directly to the subject and, optionally, one or more individuals involved in direct managerial or human resource capacities, to alert the subject of one or more upcoming training event(s). A detailed scheduling notification can be generated for the subject, for example, while a synopsis scheduling notification or a group scheduling overview can be generated and issued to management/human resources. The email notification, in some examples, can include digital calendar appointment invitations, course preparation information (e.g., training materials, background information regarding the presenter, etc.), or course access information (e.g., conference room number, driving directions, website logon information, dial-in teleconference numbers, etc.).

In addition to modules described in association with the capability accelerator application 210, the server 202 can include other applications 234. The other applications 234 can be separate or included within the capability accelerator application 210. In some examples, the other applications 234 can include a subject ranking engine which ranks the assessed subjects within a role area, group, or department based upon one or more competency areas of interest, a gap report graphing engine which generates a visual comparison of individual subjects and/or an organizational group compared to competency goals, or a role recommendation engine which can map subjects to available roles within an organization based upon proficiency within various competency areas.

Although the capability accelerator application 210 is illustrated within the storage medium 212 connected to the server 202, in some implementations additional servers and/or storage mediums can be used to provide the capabilities of the server 202 as described. For example, the different phases of the workplace staff assessment process can be executed by different servers. A first server may be accessed to create the role definitions and competency mappings using the competency mapper 220, role definer 216, sample mappings 226, and sample definitions 218. These definitions can be accessed by a second server for generating reports via the report generator 228. The data calculated by the report generator 228 can then be made available to a third server which uses the plan generator 230 and the scheduler 232 to generate and execute training plans. Other implementations are possible.

The subjects or other members of the organization can interact with the capability accelerator application 210 using the client device 204. The client device 204 can include one or more devices connected to the network 208 for use in the process of assessing workplace staff competencies. Although the client device 204 is illustrated with a user interface 236, in some implementations the client device 204 is a server accessible to one or more user devices within the organization via the network 208 (e.g., using an intranet, campus network, or internet connection). The client device 204 includes an assessment module 238 which can be used for entering assessment scores associated with various assessment activities, a computer-based training module 240 which provides training courses to improve one or more competency areas, and a management validation module 242 which provides direct managers with the opportunity to validate automated activities during the competency assessment process. A storage medium 244 connected to the client device 204 can store the software applications used for executing the assessment module 238, computer-based training module 240, or management validation module 242 as well as temporary or permanent data generated by the assessment module 238, computer-based training module 240, or management validation module 242.

In some implementations, secure access methods are established to authenticate users of the assessment module 238, computer-based training module 240, or management validation module 242. For example, a secure identifier and password can be provided to managers so only authenticated managers access the management validation module 242. In other implementations, the assessment module 238, computer-based training module 240, or management validation module 242 can be installed within specific client devices 204 on a need basis.

The assessment module 238 can be used to log proficiency scores related to competency assessment activities. For example, at the end of a competency assessment activity, each subject can be scored within one or more competency areas defined with the roles of each subject. If more than one assessor is involved in the assessment activity, the assessment module 238 may collect proficiency scores from each assessor and combine these scores to calculate a final proficiency score. The proficiency scores, in some examples, can be provided as raw data, a spreadsheet of values, or through a GUI grading tool including a graphical proficiency scale. If proficiency scores collected via two or more competency assessment activities relate to the same competency area, the assessment module 238 may combine the proficiency scores in a straight or weighted manner to calculate a final proficiency score. For example, if a first activity has a primary focus of competency A, while a second activity has a secondary focus of competency A, the proficiency scores collected from the first activity may be given a greater weight than the proficiency scores collected from the second activity. Other score weightings and/or manipulations are possible.

In some implementations, the assessment module 238 can automatically grade computer-based assessment activities such as online quizzes. For example, an online activity can be provided to a subject through the user interface 236 of the client device 204 or through a network connection to the client device 204, and the assessment module 238 can coordinate with the online activity to collect proficiency scores related to one or more competency areas.

The assessment module 238, in some implementations, includes a graphical user interface (GUI) where an assessor, manager, or subject can access information regarding the competency assessment process. For example, the assessment module 238 may calculate a percentage completed during a competency assessment process which includes multiple activities and/or provide a list of competencies which have been assessed and graded. Other capabilities of the assessment module 238 can include, in some examples, a reminder engine which can issue notifications when the proficiency scores of one or more subjects are incomplete, or a customization engine for providing customized proficiency scales or score weighting algorithms.

The assessment module 238, in some implementations, can coordinate with the management validation module 242 to validate the final proficiency scores collected for each subject. For example, the direct manager of a subject can access the management validation module 242 to review, modify, and finalize proficiency scores related to the subject before the proficiency scores are analyzed (e.g., by the capability accelerator application 210). After the proficiency scores collected by the assessment module 238 have been analyzed, the management validation module 242 can be used to validate recommended training plans and/or training schedules derived through the competency assessment process. In some implementations, the management validation module 242 can additionally be used to review subject rankings, hiring or promotional recommendations, or suggested organizational charts derived through the competency assessment process.

If training has been recommended, validated, and scheduled, one or more subjects can access the computer-based training module 240 to participate in one or more training activities geared towards the improvement of one or more competency areas. The computer-based training module 240 can include any number of online or computer-based video presentations, virtual classroom presentations, individually driven training exercises, etc. In some implementations, rather than residing within the client device 204, the computer-based training module 240 can be executed from a remote server attached to the network 208 such as the third party server 206 or the server 202 as accessed through the user interface 236 of the client device 204.

The third party server 206 includes a set of course descriptions 248 and a scheduler application 250 within a storage medium 246. The course descriptions 248, in some examples, can each include a course name, description, type (e.g., online, classroom, video presentation, etc.), duration, target competency area, and estimated competency improvement in relative (e.g., “two levels”) or absolute (e.g., “increase from level three to level four”) terms. The course descriptions 248 can also include, if applicable, available timeslots. For example, a classroom-based course may be available on the second Thursday of every month.

The scheduler application 250 can access the course descriptions 248 and create a training schedule based upon a set of competency deficiencies (e.g., as identified by the gap report generator 228). The scheduler application 250 can create the training schedule in relative or specific terms. For example, the scheduler application 250 can identify that course (i) improves competency A from level two to level three, while course (ii) improves competency A from level three to level four. If a team member has scored a level two in competency A with a desired competency level of four, the scheduler application 250 can recommend course (i) followed by course (ii). If the course descriptions include time, date, and duration, the scheduler application 250 can additionally recommend, for example, course (i) at 8:00 a.m. on Monday the 9^{th} followed by course (ii) at 8:00 a.m. on Wednesday the 10^{th}. In some implementations, the scheduler 232 within the capability accelerator application 210 accesses the scheduler 250 and/or the course descriptions 248 to generate training schedules.

When an organization commences a process for assessing workplace staff competencies, the organization can interact with the capability accelerator application 210 on the server 202 to create role definitions, one or more proficiency level scales, and competency mappings for each role definition using the role definer 216, the competency mapper 220, the competency level identifier 224, the sample mappings 226, and the sample definitions 218.

Subjects can be assessed through competency assessment activities provided in person and/or through the assessment module 238. These competency assessment activities can be designed to assess competencies associated with the role definitions provided for subjects' present or future roles within the organization. The proficiency scores collected through the various competency assessment activities can be collected, combined, or calculated by the assessment module 238 on the client device 204. The management validation module 242 may be used to modify and/or validate the proficiency scores.

The assessment module 238 can provide the finalized proficiency scores to the capability accelerator application 210 on the server 202, through the network 208. The proficiency scores are used by the gap report generator 228 to create individual and, optionally, team/group/department gap reports. These reports can be provided to the subjects and/or direct managers or other staff through the network 208 (e.g., received by the client device 204 or similar device within the organization).

The output of the gap report generator 228 can also be provided by the plan generator 230 within the capability accelerator application 210. The plan generator 230 creates training plans to improve any deficiencies found within the gap reports. The plan generator 230 can access the course descriptions 248 and/or the scheduler application 250 within the third party server 206 to match available courses with deficient competency areas.

The training plans can be provided to the management validation module 242 within the client device 204 to validate the recommended training. If two or more courses are available within the same competency improvement area, the management validation module 242 can provide the opportunity to select between available courses.

Once the training plans have been validated, the scheduler 232 generates scheduling notifications related to the training plans. The scheduling notifications can be sent to subjects, direct managers, or other staff via the network 208. For example, the client device 204 can receive the scheduling notifications.

The scheduled training courses may include one or more computer-based training modules 240. Subjects can access the computer-based training module(s) 240 through the client device 204 to obtain training within focus competency areas. Non computer-based training may also be scheduled for one or more subjects.

This process, in some implementations, may be repeated periodically to reassess subjects as the organization expands, needs change, and individual subjects' careers develop within the organization. Other applications 234 within the capability accelerator application 210 may contribute, in some implementations, to the development and growth of the organization by recommending team members for promotions, recommended potential hires for open positions, or suggesting organizational charts based upon the specific strengths and weaknesses of individual subjects as determined through the process for assessing workplace staff competencies.

Although the server 202, the client device 204, and the third party server 206 are illustrated as separate devices connected through the network 208, in some implementations a different number of devices can be used to carry out the general implementation of assessing workplace staff competencies, or the server 202, the client device 204, and/or the third party server 206 can be directly connected without the need for the network 208. Similarly, the storage mediums 212, 244, and 246 can be implemented using any number and/or type of physical storage units, such as a redundant array of independent disks (RAID), a floppy disk drive, a flash memory, a USB flash drive, an external hard disk drive, a High-Density Digital Versatile Disc (HD-DVD) optical disc drive, an internal hard disk drive, a Blu-Ray optical disc drive, or a Holographic Digital Data Storage (HDDS) optical disc drive.

Although the architecture 200 has been described as an automated system, in some implementations, one or more of the steps of the process for assessing workplace staff competencies and generating a plan to meet desired proficiency levels can be performed manually. For example, customized role definitions can be generated by a consultant working with the organization, and the role definitions can be entered into the capability accelerator application 210 or directly into the storage medium 212 by the consultant. In another example, a training consultant can access the course descriptions 248 and work with the organization to determine a training plan and schedule. Other manual customizations to the otherwise automated process are possible.

### Capability Accelerator Process

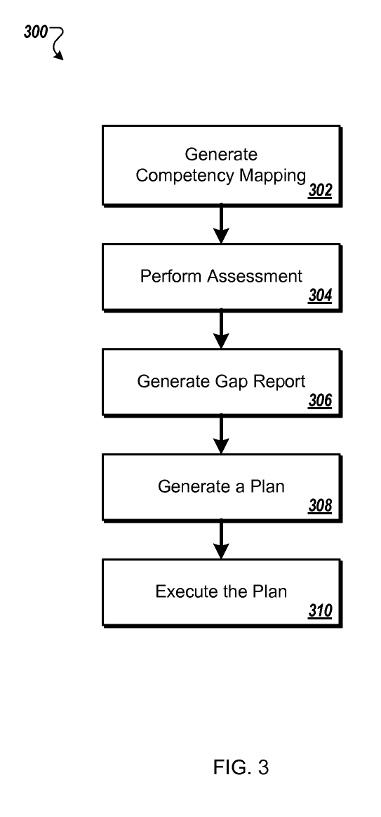

FIG. 3 is a flow chart illustrating a method 300 in accordance with one general implementation. Briefly, the method 300 involves describing various job positions within an organization in terms of roles which involve one or more competencies, assessing subjects based upon these competencies, and generating individualized plans for improving the performance of subjects within any competency areas where deficiencies were found. The method 300 can be used, for example, to improve the performance of a group, department, or organization through analyzing the competencies of individuals and strengthening areas of weak performance.

The method 300 provides a structured approach to supporting a workplace staff transformation exercise, by identifying and enhancing individual and collective capabilities. As a brief overview, according to the method 300, a competency mapping is developed for an organization, where the competency mapping identifies the various personnel roles required (or desired) in the organization, the competencies necessary (or desired) to perform each role, and the proficiency levels necessary (or desired) for each competency. The current or prospective employees of the organization are assessed to determine their actual proficiency levels for the required (or desired) competencies by their present or future role within the organization. For each assessed subject, gaps between their actual proficiency levels and the necessary (or desired) proficiency levels are identified, for example through a gap report, and addressed, for example by automatically scheduling training which is specific to a particular identified gap.

In more detail, when the method 300 begins (step 302), competency mappings are generated. The competency mappings identify one or more competencies required to perform a role in the organization and, for each competency, a desired proficiency level selected among multiple proficiency levels defined for the competency. These competency mappings can also be referred to as role definitions. The competencies listed within the competency mappings, for example, can include one or more prescribed or expected behaviors associated with a particular position or status in the organization. Each proficiency level defined for the competencies can specify an extent to which the assessed subject exhibits a respective competency. In one example, the proficiency levels can include an “awareness” proficiency level, a “functioning” proficiency level, a “skilled” proficiency level, and an “expert” proficiency level. In another example of a proficiency scale, the levels can be defined as “significantly below expectations”, “below expectations”, “meets expectations”, “exceeds expectations”, and “significantly exceeds expectations”. A given competency can be associated with two or more roles, and, in some cases, a different desired proficiency level can be selected dependent upon the role. For example, a junior group member may share a competency requirement with his or her direct manager, but the proficiency level expected of the direct manager may be higher than the proficiency level expected of the junior group member.

In some implementations, a database of previously generated competency mappings can be accessed to form the basis for the organization's competency mappings. These sample competency mappings, for example, may have been generated for one or more other organizations. The database may additionally include fields regarding attributes associated with the other organization(s), such as, for example, the type, size, or level of maturity of the organization. When generating a competency mapping, a sample mapping can be selected and, if desired, customized for the needs of the organization. In other implementations, competency mappings can be generated from scratch or through the customization of very basic example competency mappings.

In other implementations, a consultant can work with the organization to manually generate customized role definitions, proficiency level scales, or competency mappings, optionally based upon existing or template information. For example, the consultant can guide the organization through establishing competency mappings which realistically portray the goals and interworkings of the organization.

A competency assessment is performed on a subject (step 304). The competency assessment assesses the proficiency level of the subject for each competency included within the mapping associated with the role of the subject. A competency can be assessed through a variety of competency assessment activities such as, in some examples, conducting an interview of the subject, testing the subject using a psychometric test, conducting a group discussion with the subject, role playing with the subject, or performing an online testing exercise with the subject. One or more competencies can be assessed through each competency activity. In some implementations, the same competency can be tested two or more times throughout the competency assessment process. For example, a particular competency may be assessed through both an online test and a role playing activity.

For each competency assessment activity, the one or more competencies tested can be scored by an assessor. The assessor assigns an exhibited proficiency level to each competency. Two or more assessors can provide scores for each subject during the competency assessment activity. For example, during a group discussion activity, two or three assessors can participate, each assessor later scoring each subject participating in the group discussion activity. These scores can be combined (e.g., average, weighted average, median, etc.) to arrive at a final exhibited proficiency level. In the case of an online test or computer-based psychometric evaluation, the proficiency level scores may be automatically generated.

In addition to performing and scoring competency assessment activities, in some implementations the proficiency level scores may be validated by an outside person. For example, the direct manager of the subject or another in a close leadership role may review the proficiency level scores of a subject and modify or validate the results. In some cases, a reassessment can be requested for one or more competencies based upon unexpected proficiency scores.

Once all of the proficiency scores for each competency within the competency mapping have been calculated and validated, a gap report is generated (step 306). The gap report compares the desired proficiency levels within the competency mapping with the proficiency level scores obtained through the competency assessment and identifies, for each competency, any discrepancy between the desired proficiency level and the observed proficiency level of the subject. The gap report can be limited to machine-readable data, or the gap report can be a printed text and graphics based report which can be shared with the subject, direct manager, or other leadership within the organization.

The gap report can include, in some implementations, a visualization of the competency mapping and the competency assessment. For example, a bar graph, line graph, or other visual display can provide a viewer with a simple overview of competency strengths and weaknesses of the subject. The visualization can additionally include a comparison of the subject in relation to peers (e.g., the rest of the group members) or an overview of the competency strengths and weaknesses of the team, group, or department as a whole.

In some implementations, a consultant works with the organization to manually customize one or more gap report templates. The gap report templates, for example, can be added to the automated system so that the gap report information provided to individual subjects or group gap reports generated for organizational management convey desired information in an easy to digest manner.

Based upon the gap report, a plan for reducing or eliminating one or more discrepancies is generated (step 308). The plan can include establishing a training schedule to improve the performance of the subject in one or more areas. For example, using a digital catalog or database of training courses, one or more courses designed to address the discrepancy can be automatically selected. The course catalog can include indicators regarding which competency or competencies each course covers and the expected proficiency increase the course can provide. The proficiency increase may be described in relative terms, such as two proficiency levels, or absolute terms, such as an increase from level three to level four proficiency.

In some implementations, a training consultant guides the organization through manually establishing a training plan. For example, the consultant can present options regarding training activities, training styles, or scheduling plans.

The plan can additionally or alternatively include a hiring or promotion recommendation or a succession plan. For example, the plan can include a ranking of subjects in terms of being hired or promoted to a role. In terms of a succession plan, individualized training plans, along with an estimated time investment, can be provided for each of a number of subjects with the goal of eradicating the competency deficiencies of each individual such that any one of the individuals can be prepared to eventually step into the next rung of the organizational chart. If more than one career path is available, the plan may suggest which path each subject appears best suited to follow.

The training plan(s), succession plan(s), or hiring/promotional recommendations can be furnished to a direct manager or other leadership in the organization. In some implementations, the training plan can be adjusted or validated by the manager before becoming finalized. For example, if two or more courses are available which cover the same competency area, the manager may be provided the opportunity to select a course option on behalf of the subject. The manager may also be given the ability to determine the priority of training courses. For example, the training plan could include multiple increases within a single competency area, along with multiple competencies at each proficiency level. The manager may decide between increasing a specific competency to completely close the gap, or providing training in each competency gap across the lowest proficiency level before continuing on with increasing one or more competencies within higher proficiency levels. Other customization options can be available within the training plan.

Once a training plan has been finalized, the plan is executed (step 310). For example, a message can be generated to inform the subject of one or more employment or training action(s) which resulted based on one or more discrepancies. If the subject is scheduled to attend a training course, the message can include information regarding the date, time, location, and content of the training course. Delivery of the message can include, in some examples, generating a digital calendar action, sending an email notification, or adding an action item to an online employee dashboard. In addition to notifying the subject, in some implementations, the direct manager or other leadership can automatically be notified regarding the scheduling and execution of the training plan. This notification can include individual or summary messages regarding one or more subjects who have taken part in the competency assessment process.

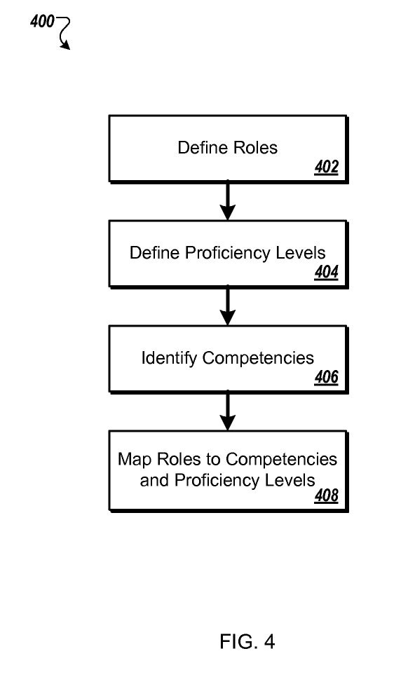

FIG. 4 is a flow chart illustrating a method 400 in accordance with another general implementation. Briefly, the method 400 involves creating role definitions which describe each position within an organization according to competencies required to perform the respective position and a desired proficiency level selected among multiple proficiency levels defined for each of the respective competencies. The method 400, for example, can be performed during generation of a competency mapping (step 302) of the method 300, as described in relation to FIG. 3.

In more detail, when the method 400 begins (step 402), roles are defined. Each role can translate to a position or status in an organization. The role can be expressed in terms of a job title and/or description as well as responsibilities or accountabilities associated with each role. In one example, the role of Performance Management can be summarized as “oversees implementation and execution of annual performance management activities for the organization”. The responsibilities of the role of Performance Management can be described as “development and maintenance of the overall performance management framework of the organization; leadership of specified performance management and service development issues; and cooperation with human resources business partners to ensure implementation of the value propositions”.

A user can generate the roles, in some examples, using a graphical software application, a spreadsheet, or a relational database interface. In other implementations, a consultant can work with a user (e.g., member of an organization) to manually determine role definitions. The roles can be stored within a database or digital catalog, or uploaded to a third party organization which oversees the implementation of assessing competencies within organizations and generating plans to meet desired proficiency levels.

In some implementations, roles can be selected from a database of sample roles. The sample roles can optionally be customized based upon the needs of the organization. For example, based upon attributes of the organization, a basic set of roles can be accessed (e.g., human resource roles of a small young organization in the services industry, information technology support roles of a large mature organization in the medical industry, etc.). These roles may be modified, deleted, or appended to as necessary to best describe the role structure of the organization.

Proficiency levels are defined (step 404). A proficiency scale with two or more proficiency levels can be defined which encapsulates the gradations of proficiencies which a subject may exhibit within a role. For example, for a given competency, a subject can be novice, advanced, or expert within that area. The proficiency levels can be used to accurately describe a subject's level of comfort or knowledge within a given competency. Because competencies can cover many types of skills, including, in some examples, basic office skills, interpersonal skills, management skills, or technology skills, each competency or each grouping of competencies can be associated with a different proficiency scale.

In some implementations, a generic proficiency scale of N number of proficiency levels can serve as the basis for describing proficiency levels for each competency within a role. An exemplary broadly-termed proficiency scale can include an “awareness” proficiency level, a “functioning” proficiency level, a “skilled” proficiency level, and an “expert” proficiency level. For each competency or competency grouping, a more precise definition can optionally be defined for each proficiency level. For example, a proficiency scale related to a Coaching Skills competency which maps to the generic proficiency scale mentioned above can be defined as “awareness: designs processes and systems that build coaching capabilities”, “functioning: communicates the business case for developing the coaching competency of managers”, “skilled: develops the business case for building a coaching culture in the organization”, and “expert: defines the coaching philosophy of the organization and provides strategic oversight to the process”.

For each role, competencies are identified (step 406). Competency definitions can include a competency name and a process indicator that best exhibits application of the competency in practice. Each competency definition can also include a brief description of the competency. For example, the Coaching Skills competency can be broadly defined as “actively building a culture of guidance and support”.

Roles are mapped to competencies and proficiency levels (step 408). Each role can be populated with a set of core competencies which define the capabilities and skill sets required to perform the role, along with a desired proficiency level within each competency area needed to perform well within the role. The defined proficiency level can, in part, depend upon the level of direct involvement the role has with the competency. For example, in some circumstances, a team member can be expected to have a greater level of proficiency in a particular skill than the manager of the team member, because the team member is actively involved in the application of the skill, while the manager oversees the end result of the application of the skill.

In a general example, the competencies within a given role can include planning and organizational skills, computer expertise, judgment and decision making skills, process compliance, customer orientation, attentiveness to detail, verbal communication skills, teamwork skills, and written communication skills. Each of these competencies can be accorded a desired proficiency level, and, optionally, a customized proficiency scale to describe the varying levels of competency.

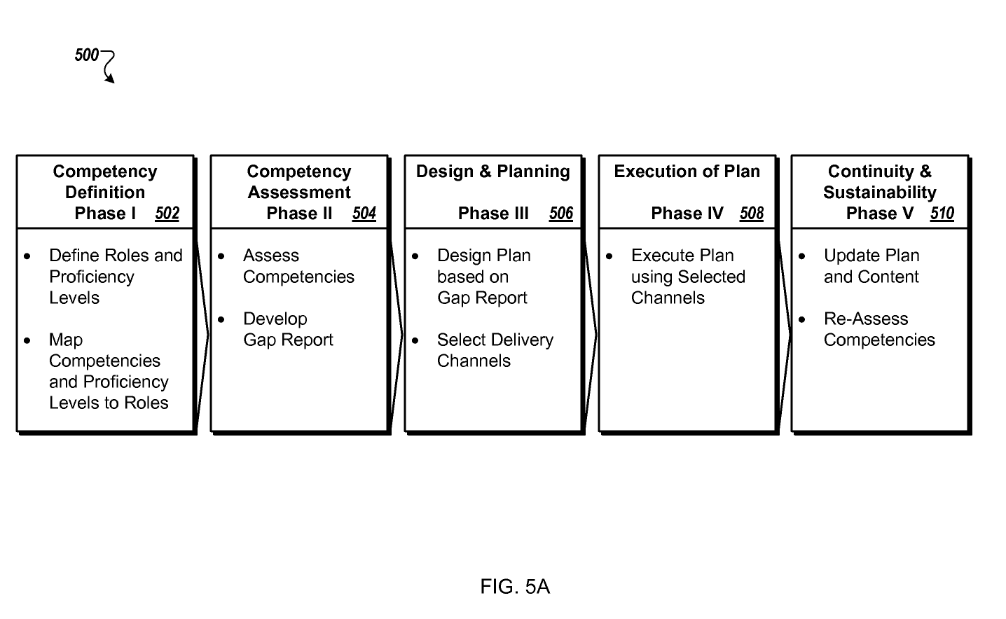

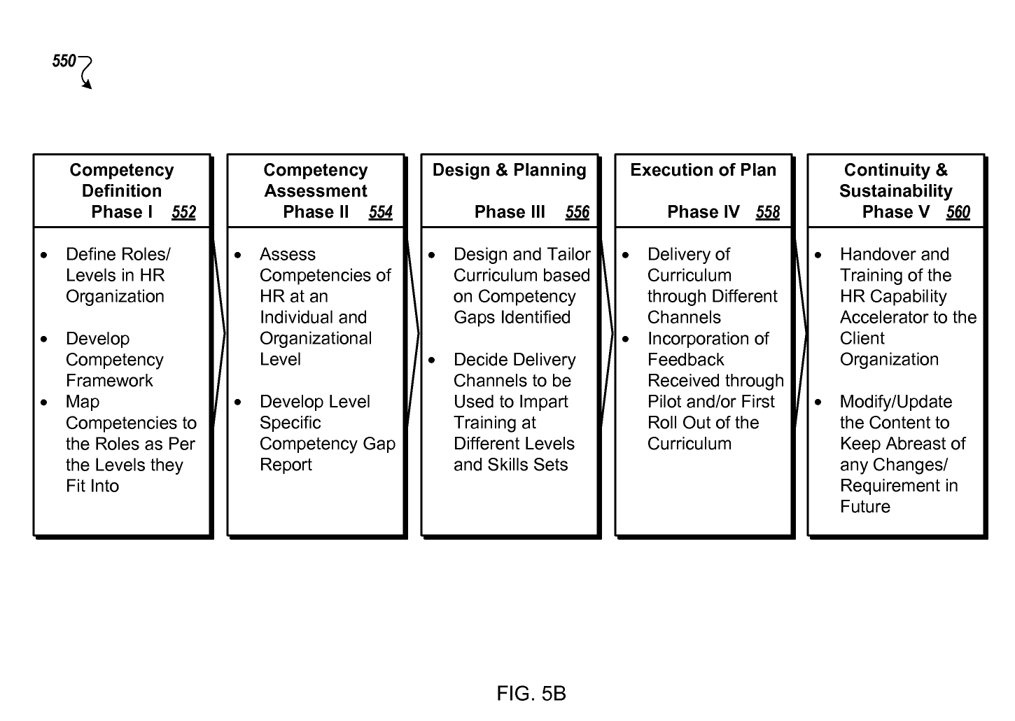

FIG. 5A is a process flow diagram 500 illustrating exemplary steps taken in executing an assessment of workplace staff competencies and generating a plan to meet desired proficiency levels. The process is broken into five phases, each phase including one or more action items. The process illustrated within the process flow diagram 500, for example, can be executed by the system 100 as described in relation to FIG. 1 using the architecture 200 as described in relation to FIG. 2.

During a first competency definition phase 502, roles, competencies, and proficiency levels are defined. Competencies and associated proficiency levels are then mapped to the roles. The first competency assessment phase 502 develops the framework for assessing workplace staff competencies.

With this framework established, the process flow enters a second competency assessment phase 504. In this phase, competencies are assessed at individual and organizational levels through a variety of competency assessment activities which are scored on the defined proficiency level scale(s). Based upon these competency assessments, gap reports are developed. The gap reports can optionally be distributed to the subjects who participated in the competency assessment activities and/or the direct management or other organizational leadership.

With information from the gap reports, a third design and planning phase 506 begins. A plan is designed based upon the gap report. For example, curriculum can be individually tailored to subjects based upon identified competency gaps and delivery channels can be chosen to provide training for different levels and skill sets. In addition, hiring, promotional, and succession recommendations can be made based upon relative performance of two or more subjects being assessed for a given role.

The plan is put into action during a fourth execution of plan phase 508. Curriculum is delivered through different channels. Hiring, promotional, and succession decisions are made. Feedback received throughout the first three phases 502, 504, and 506 can be reviewed and, in some cases, incorporated into the structure of the first three phases 502, 504, and 506.

During a fifth competency definition phase 510, for example, feedback regarding deficiencies within one or more role definitions or pitfalls encountered during one or more competency assessment activities can be used to make modifications to the structure of the first three phases 502, 504, and 506. If any reassessment requests were issued as feedback during the third design and planning phase 506 or the fourth execution of plan phase 508, these competencies can be reassessed through returning to the second competency assessment phase 504.

All or a portion of the process flow diagram 500 can be repeated as necessary. For example, periodically, the second phase 504 through the fifth phase 510 can be executed to continually review and improve upon the capabilities of the organization. An organization, in another example, can choose to execute the process flow diagram 500 on a role-by-role, group-by-group, or department-by-department basis until the entire desired segment of the organization has been added to the competency assessment and training program. In the circumstance of a layoff, acquisition, or organizational realignment, the process flow diagram 500 can be repeated to take into account the new structure of the organizational hierarchy.

In some implementations, each phase of the process flow diagram 500 can be executed using different software modules, computer servers or other computing devices. For example, one or more portions of the process flow diagram 500, such as the second competency assessment phase 504, can be conducted by a third party organization. Portions of each phase, in some implementations, can be executed manually, for example with the guidance of a third party consultant. In other implementations, the processes can be executed more or less automatically.

FIG. 5B is a process flow diagram 550 illustrating an example end-to-end solution of the process flow diagram 500 of FIG. 5A applied in a human resource department context. The process, for example, can be executed as a joint effort between an organization and a third party vendor.

During a first competency definition phase 552, roles and proficiency levels are defined for the human resources organization. A competency framework is developed based upon these roles and proficiency levels. For example, competencies are mapped to each role in accordance to the proficiency level the role fits. In some implementations, a competency assessment consultant helps the organization in manually developing the competency framework. In other implementations, the competency framework is automatically generated, for example using a computer-based software application.

Once the competency framework has been completed, the process flow enters a second competency assessment phase 554. In this phase, competencies of the human resource department at both the individual and organizational level are assessed, for example, using a variety of assessment activities and techniques. Level-specific competency gap reports are developed based upon the assessment results. The gap reports, in some implementations, are provided in a format created based upon the needs and expectations of the organization. For example, the competency assessment consultant can work with the organization to determine one or more competency gap report formats. In other implementations, the organization selects from one or more gap report templates if visual gap reports are desired; otherwise, the gap reports are stored as data which can be used by subsequent phases of the process flow.

With information from the gap reports, a third design and planning phase 556 begins. Curriculum is individually designed and tailored for subjects based upon identified competency gaps. For example, a training consultant can work with the organization in determining a training format involving role-specific training modules. In another example, the training program can be automatically generated based upon the information in the gap reports and available training modules listed within a computerized course catalog. The training modules, for example, can be used to accelerate and deepen the development of the organization's human resources staff and move the organization towards improved productivity and output. Delivery channels are chosen for imparting training at different levels and different skill sets. In some implementations, curriculum listed within a course catalog can be customized to meet the needs of the organization and delivered throughout the organization (e.g., locally, nationally, or globally).

The plan is put into action during a fourth execution of plan phase 558. Curriculum is delivered through different channels. Feedback received regarding the first phase 552, the second phase 554 or the third phase 556 can be incorporated to the program. Based upon the performance of a pilot or first roll out of the process flow, for example, one or more of the phases 552, 554, and 558 can be adjusted based upon feedback before further launching the process within the organization.

During a fifth competency definition phase 560, the established architecture for assessing workplace staff competencies and generating a plan to meet desired proficiency levels, including the role definitions, assessment activity plans, and training curriculum, can be handed over to the organization. For example, the third party vendor can train the organization in continuing to evolve the architecture and execute the assessment process to continue to develop workplace staff. The organization, in some implementations, can modify or update the content to keep abreast of changes in the organization. In other implementations, future requirements can involve returning to the third party vendor to make significant modifications to meet the changing needs of the organization.

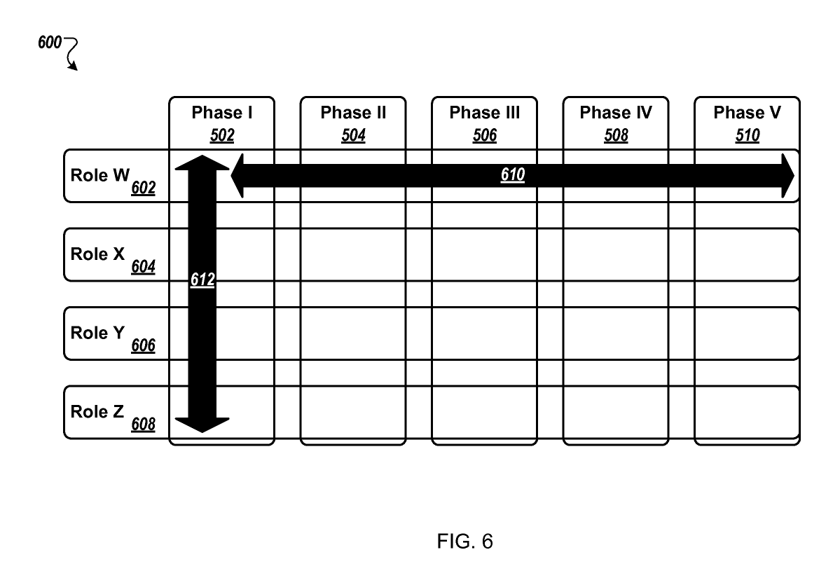

FIG. 6 is a phase execution flow diagram 600 illustrating execution options for the process flow diagram 500 as described in relation to FIG. 5. A vertical list of role definitions, including a first role W 602, a second role X 604, a third role Y 606, and a fourth role D 608 are arranged at the left side of the phase execution flow diagram 600. The process flow phases described in FIG. 5, specifically the first competency definition phase 502, the second competency assessment phase 504, the third design and planning phase 506, the fourth execution of plan phase 508, and the fifth competency definition phase 510 are aligned horizontally across the phase execution flow diagram 600.

A horizontal arrow 610 illustrates the first phase 502 through the fifth phase 510 being executed for a given role (e.g., the first role W 602). In this manner, a single team or group may be selectively directed through the competency assessment and training program.

A vertical arrow 612 illustrates the first competency definition phase 502 being executed across all of the role definitions, the first role W 602 through the fourth role Z 608. In this manner, one or more groups or departments or the entire organization can be subjected to the competency assessment and training program on a phase-by-phase basis.

Other implementations are possible. In some implementations, an organization may choose to first subject role W 602 to a horizontal execution of the five phases 502-510 as a pilot program. For example, the pilot program can include interaction with a third party vendor consultant to manually establish a process which is customized to meet the needs of the organization. Once the organization has determined a structure and implementation method suitable for the organization, the other roles X 604, Y 606, and Z 608 may be added at once, implementing a vertical execution as illustrated by the vertical arrow 612. For example, the third party vendor, after making any modifications desired based upon feedback received regarding the pilot program, can train the organization in going forward with using the architecture and process for assessing workplace staff competencies.

In another example, the roles 602-608 may be executed horizontally through the first three phases 502, 504, and 506 to complete the assessment portion of the competency and training program. In the case that multiple competencies overlap in different roles 602-608, the fourth execution of plan phase 508 may be executed vertically to provide training curriculum which combines subjects from various organizational roles. Similarly, the fifth competency definition phase 510 can be executed upon completion of the fourth phase 508.

### Phase I: Competency Definition

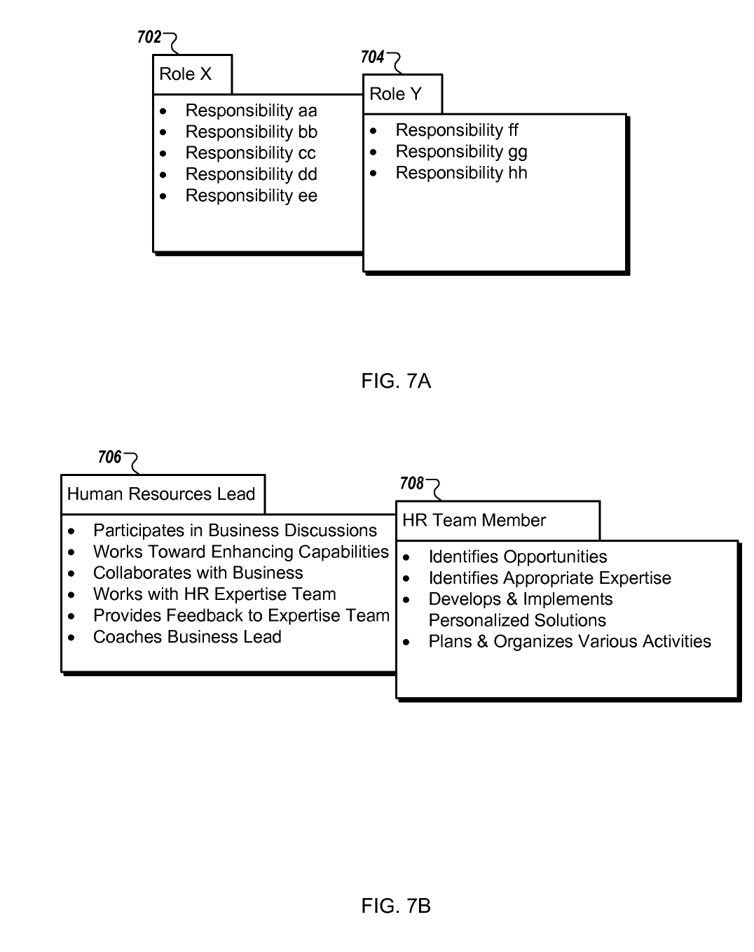

FIGS. 7A and 7B illustrate example role definitions. The role definitions, as shown, describe a position within an organization in the terms of a role name or title and a list of responsibilities associated with the role. The roles illustrated in FIGS. 7A and 7B can be defined, for example, during the first competency definition phase 502 of the process flow diagram 500 as described in FIG. 5. The role definitions can be generated by the role definer module 216 of the capability accelerator application 210, as described in relation to FIG. 2. In other implementations, the role definitions can be created manually, for example with the help of a competency assessment consultant, and uploaded to the capability accelerator application 210.

In FIG. 7A, a first role X 702 is associated with responsibilities aa through ee, while a second role Y 704 is associated with responsibilities if through hh. In other examples, overlap within the responsibilities of two different roles is possible. Role X 702 and role Y 704 can be viewed, for example, as exemplary role structures.

FIG. 7B illustrates a human resources lead role 706 and a human resources team member role 708. The roles 706 and 708, for example, can be used to define a portion of an overall human resources department. Other positions within a human resources department are possible, and other responsibilities are possible within the human resources lead role 706 and the human resources team member role 708.

The human resources lead role 706 includes the following responsibilities: “participates in business discussions”, “works toward enhancing capabilities”, “collaborates with business”, “works with human resources expertise team”, “provides feedback to human resources expertise team”, and “coaches business lead”. These responsibilities can be used, in part, to select competencies related to the human resources lead role 706. For example, the responsibility “coaches business lead” can be associated with a competency “coaching and mentoring” or “interpersonal skills”.

The human resources team member role 708 includes the following responsibilities: “identifies opportunities”, “identifies appropriate expertise”, “develops and implements personalized solutions”, and “plans and organizes various activities”. These responsibilities likely require some of the same competencies and some different competencies than the human resources lead role 706. In the event of overlapping responsibilities, the human resources team member role 708 may be associated with a different proficiency level than the human resources lead role 706. The competencies can be mapped to the role definitions, for example, using the competency mapper 220 of the capability accelerator application 210, as described in relation to FIG. 2.

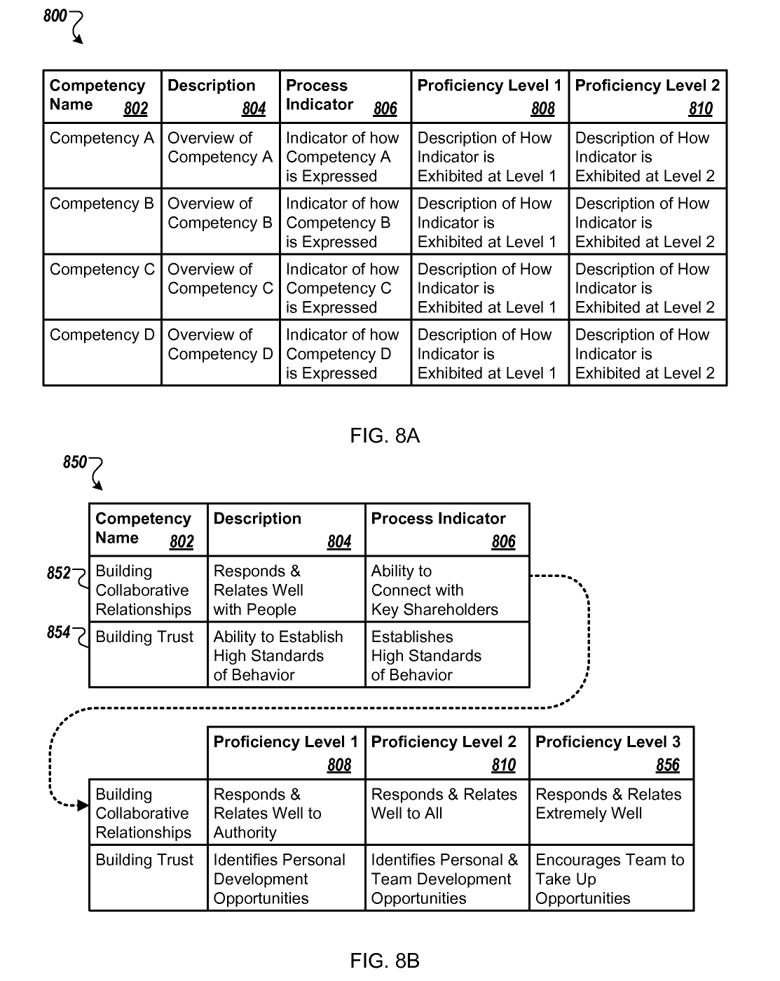

FIGS. 8A and 8B illustrate example competency definitions. The competencies, for example, describe skills or behaviors desirable in subjects who are hired to perform a given role. Upon establishment of the competency definitions, each competency can be mapped to one or more role definitions, such as the human resources lead role 706 or the human resources team member role 708 as described in relation to FIG. 7B. In some implementations, the competencies are automatically generated, for example through customization of competency definition templates accessible through a software application. In other implementations, the competency definitions are manually established, for example through interfacing with a competency assessment consultant, to customize competencies to meet the needs of the organization.

FIG. 8A illustrates a generic competency matrix 800. The competency matrix includes a competency name column 802 providing a brief name of each competency, a competency description column 804 including a brief overview of each competency, and a process indicator column 806 including an indicator of how each competency is expressed.

Following this descriptive information, two or more columns can be used to describe the behavior or skill set exhibited by a subject at each proficiency level within an n-level proficiency scale. For example, the competency matrix 800 includes a proficiency level 1 column 808 and a proficiency level 2 column 810, suggesting a two-level proficiency scale. Within the proficiency level 1 column 808, for example, a description can be entered of how the process indicator described within the process indicator column 806 may be exhibited at the first, or lowest, proficiency level. Similarly, within the proficiency level 2 column 810, a description can be entered of how the process indicator of the process indicator column 806 may be exhibited at the second proficiency level. Any number of proficiency levels is possible.

Referring to FIG. 8B, an exemplary competency matrix 850 details the contents of two competency definitions, a building collaborative relationships competency 852 and a building trust competency 854. The columns of the competency matrix 850 are identical to the competency matrix 800, except there is a third proficiency level column 856 added.

According to the building collaborative relationships competency 852 (e.g., the name listed within the competency name column 802), the description column 804 contains the description “responds and relates well with people”. Within the process indicator column 806, an indicator of how the building collaborative relationships competency 852 can be expressed is listed as “the ability to connect with key shareholders”. Within the proficiency level 1 column 808, a description of how the indicator may be exhibited at proficiency level I is described as “responds and relates well to authority”. In comparison, within the proficiency level 2 column 810, the description is described as “responds and relates well to all”, while within the proficiency level 3 column 856, the description is described as “responds and relates extremely well”. These descriptions of how an indicator is exhibited, as listed within the proficiency level 1 column 808, level 2 column 810, and level 3 column 856 can help to guide an assessor, for example, in scoring a subject's proficiency level during a competency assessment activity.

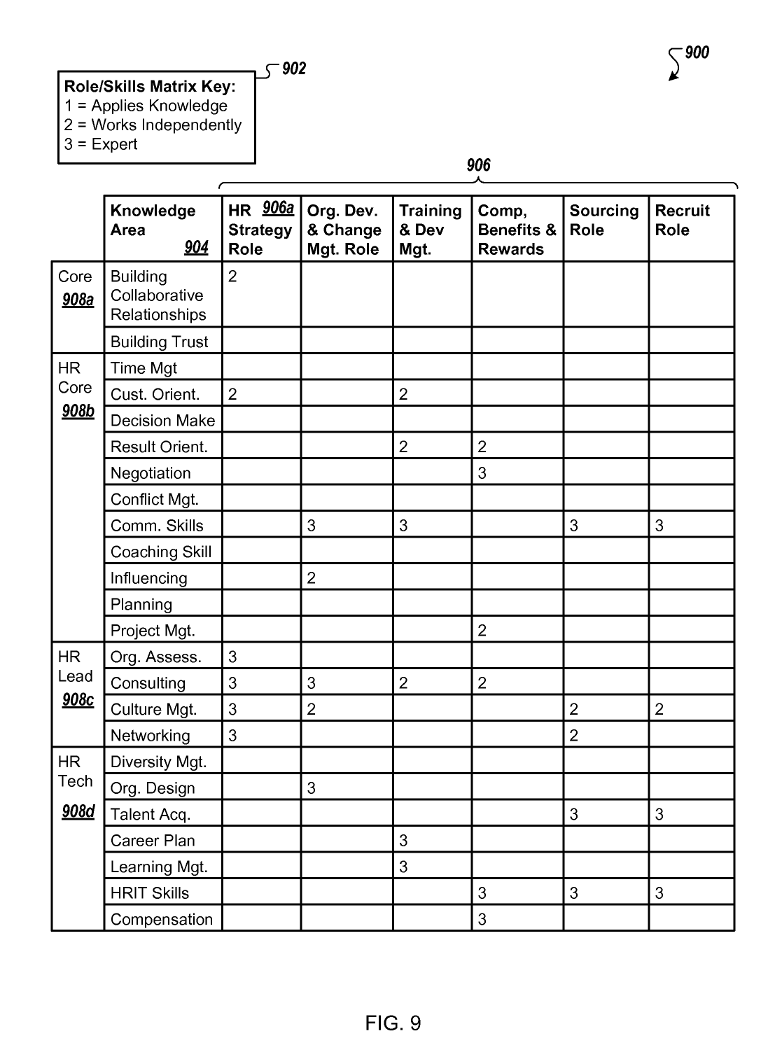

FIG. 9 is a table illustrating an example skills matrix 900. A skills matrix is a tool which can be used when mapping competencies and associated proficiency levels to individual roles. As indicated by a matrix key 902, a proficiency level scale for the listed competencies is described as level 1 “applies knowledge”, level 2 “works independently”, and level 3 “expert”. The skills matrix 900 contains a first column 904 describing individual competencies, listed as “knowledge areas” and columns 906 listing individual roles.

The rows 904 are grouped by skill sets 908. For example, within a core skill set 908a, the competencies “building collaborative relationships” and “building trust” are listed. Other skill sets include a human resource core skill set 908b, a human resource leadership skill set 908c, and a human resource technologies skill set 908d. The skill sets, for example, can be used in guiding the mapping of competencies. For example, to perform well within a human resources strategy role 906a, strong human resource leadership skills, such as those listed within the human resource leadership skill set 908c, are required. For each of the competencies listed within the human resources skill set 908c (e.g., organizational assessment, consulting, culture management, and networking), a proficiency level of 3 is listed beneath the human resource strategy role 906a.

In one example, a skills matrix software tool can be used to present the skills matrix 900. Upon completion of the skills matrix 900, for example, competency mappings can be automatically generated (e.g., populated within a database). The skills matrix tool, for example, can be included within the competency mapper 220 of the capability accelerator application 210, as described in relation to FIG. 2. In another example, a competency assessment consultant can present the skills matrix 900 to a member of the organization as a visual tool which aids in the development of competency mappings.

### Phase II: Competency Assessment

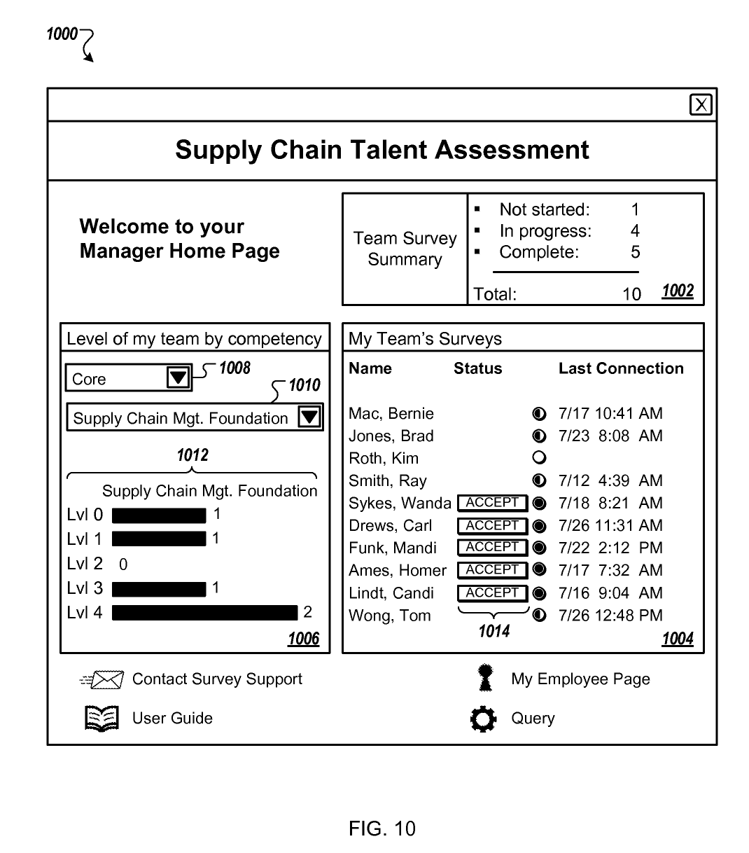

FIG. 10 depicts an example user interface 1000 for managing talent assessment surveys. The user interface 1000, for example, can be accessed by a manager while the manager's team or group is partaking in one or more competency assessment activities, allowing a manger to monitor and, potentially, validate the results of competency assessment activities. The user interface 1000, for example, can be generated by the management validation module 242, as described in relation to FIG. 2. The user interface 1000 includes a survey summary region 1002 including a snapshot of the progress of an overall group or team during a competency assessment process, a survey progress report region 1004 to track the progress of individual subjects within the team or group, and a team assessment overview region 1006 to quickly review the overall team competency scores.

The user interface 1000 provides a brief overview of the progress of a manager's group during a supply chain management foundation competency assessment activity. In the team assessment overview region 1006, the core competency skill set has been selected from a skill set drop-down menu 1008. The contents of the skill set drop-down menu 1008, for example, can match the skill sets 908 listed within the skills matrix 900 as shown in FIG. 9 or serve a similar purpose to the skill sets 908. Beneath the skill set drop-down menu 1008, a competency drop-down menu 1010 contains the selection “supply chain management foundation”. The selections made within the drop-down menus 1008 and 1010, for example, can determine the information reviewed within the user interface 1000.

According to the survey summary region 1002 of the user interface 1000, a total of ten subjects are participating in the supply chain management foundation competency assessment activity. Of the ten subjects, one subject has not begun the process, four subjects are currently in progress, and five subjects have completed the competency assessment activity. Returning to the team assessment overview region 1006, the proficiency level scores of the five subjects who have completed the competency assessment activity are included within a proficiency level overview bar graph 1012. According to the proficiency level overview bar graph 1012, one subject scored at proficiency level zero, one subject scored at proficiency level one, one subject scored at proficiency level three, and two subjects scored at proficiency level four.

Within the survey progress report region 1004, individual subjects are listed by name, status (e.g., not started, in progress, or complete), and time of last connection. The five subjects listed who have each completed the supply chain management foundation competency assessment activity are each associated with accept buttons 1014 within the status column.

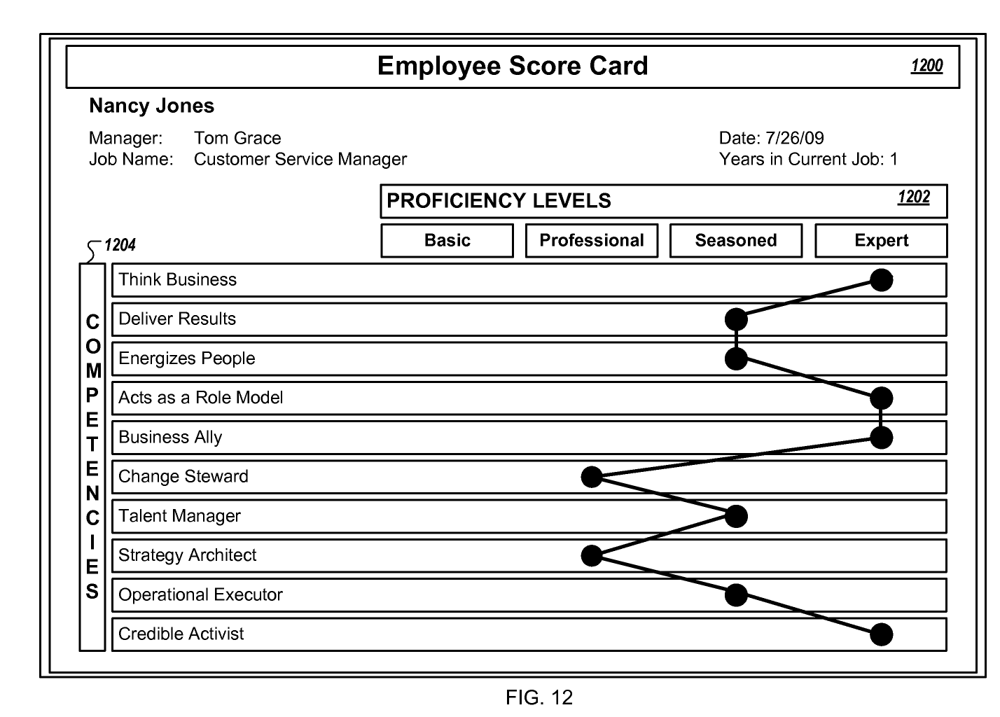

In some implementations, through selection of one of the accept buttons 1014, the manager accessing the user interface 1000 can review and validate the results of the associated subject's proficiency scoring. In some examples, activating one of the accept buttons 1014 can launch a pop-up window, navigate the manager to a new window, or otherwise provide an individualized competency assessment score card (e.g., such as the score card 1200 shown in FIG. 12) for the manager's review and acceptance. In other implementations, the individual competency assessment proficiency level scoring results are delivered to the manager separately (e.g., email, fax, separate web page, etc.). For example, selection of one of the accept buttons 1014 can simply provide validation to the results of the competency assessment. Upon validation of survey results, in some examples, the results can be shared with the subject, used to generate a gap report, or used to determine a training plan for the subject.

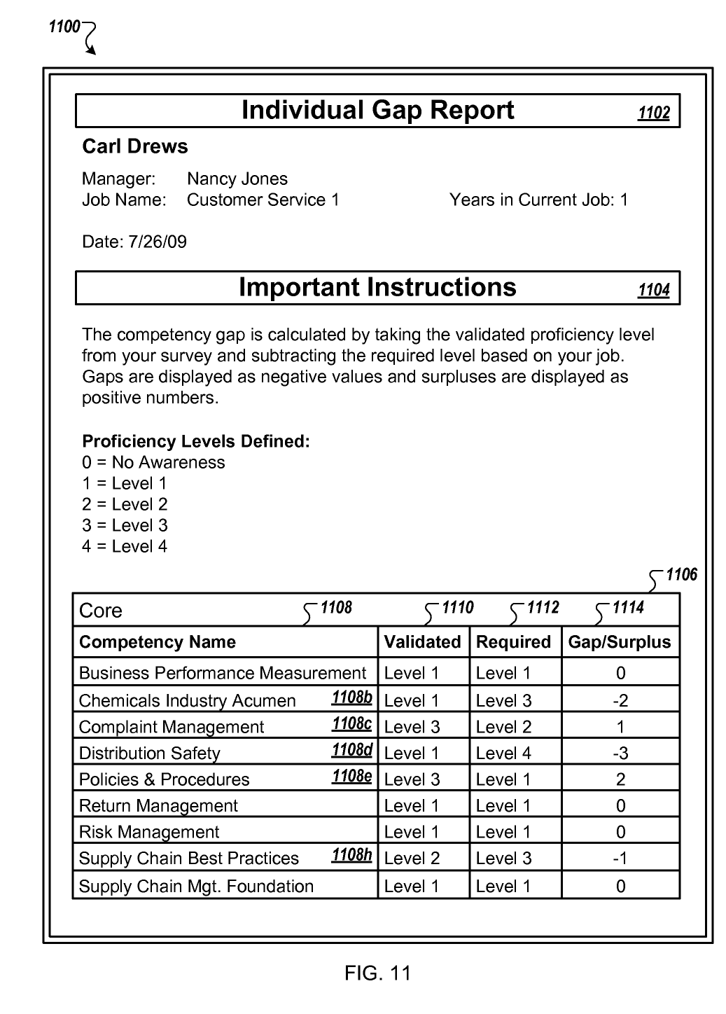

FIG. 11 depicts an example individual gap report 1100 detailing the differences between desired proficiency levels within assessed competencies and validated proficiency level scores of the individual. The individual gap report 1100 includes a subject information section 1102 detailing information regarding the subject who participated in the competency assessment process, an instructions section 1104 explaining the gap analysis information, and a gap analysis table 1106 providing the proficiency scores relating to each of the competency assessment activities. The gap report 1100, for example, can be shared with the subject (e.g., Carl Drews) or the manager of the subject (e.g., Nancy Jones) to review the strengths and weaknesses of the subject and to aid in determining a plan of action regarding the deficiencies of the subject. In some examples, the individual gap report 1100 can be used when making hiring, firing, or promotional decisions. The individual gap report 1100, in one example, can be generated by the gap report generator 228 of the capability accelerator application 210, as described in relation to FIG. 2. The format of the individual gap report 1100, in some implementations, is selected by the organization from a series of gap report templates which visually portray the results of competency assessment activities in a variety of methods. In other implementations, the individual gap report 1100 format is customized, for example by a third party vendor, based upon the needs and expectations of the organization.

The gap analysis table 1106 includes a competency column 1108, a validated proficiency level column 1110 listing the scored proficiency levels obtained from the competency assessment activities, a required proficiency level column 1112 containing values obtained from the role definition mappings, and a gap/surplus column 1114 listing the difference, if any, between the validated proficiency level column 1110 and the required proficiency level column 1112. According to the gap analysis table 1106, the subject Carl Drews has a deficiency of two levels in a chemicals industry acumen competency 1108b, a deficiency of three levels in a distribution safety competency 1108d, and a deficiency of one level in a supply chain best practices competency 1108h. The deficient competency areas 1108b, 1108d, and 1108h, for example, may suggest areas in which training can be offered.

The results listed within the gap analysis table 1106 also include two areas of surplus proficiency: the subject exhibited an excess proficiency of one level in a complaint management competency 1108c and an excess proficiency of two levels in a policies and procedures competency 1108e. The surplus competency areas 1108c and 1108e, for example, can suggest strengths which may position the subject for consideration in promotion, new hire, or internal transfer.

FIG. 12 depicts an example employee score card 1200 for graphically displaying individual results of a competency assessment process. Proficiency levels of “basic”, “professional”, “seasoned”, and “expert” are plotted on an x-axis 1202, while individual competency areas are listed on a y-axis 1204. The employee score card 1200 can be provided to a subject or the manager of the subject for a quick overview of relative strengths and weaknesses of the subject. In one example, a manger can review the employee score card 1200 when validating competency assessment proficiency level scores. In other implementations, employee score cards can be depicted listing individual text scores or using other graphing methods such as a bar graph.

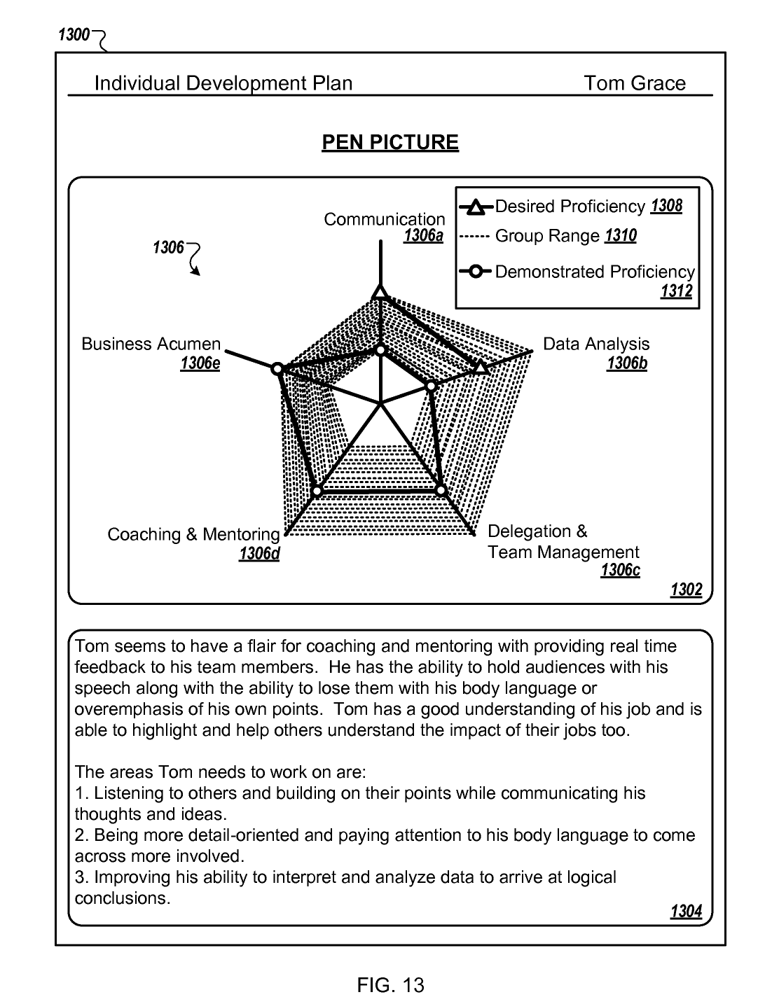

FIG. 13 depicts an example personal development report 1300, detailing the relative strengths of a subject based upon the results of a competency assessment process. The personal development report includes a proficiency distribution graph analysis area 1302 and a feedback area 1304. The personal development report 1300, for example, can be discussed between a subject and the manager, group leader, or mentor of the subject.

The proficiency distribution graph analysis area 1302 provides a comparison between the subject and the overall group (e.g., group members or job candidates within a given role definition) who participated in the competency assessment process. The proficiency distribution graph analysis area 1302 includes a star graph 1306 with five arms: a communication arm 1306a, a data analysis arm 1306b, a delegation & team management arm 1306c, a coaching & mentoring arm 1306d, and a business acumen arm 1306e. Each arm of the star graph 1306, for example, can relate to a competency or a cluster of related competencies. The star graph includes a desired proficiency plot 1308, a group range plot 1310, and a demonstrated proficiency plot 1312.

The star graph 1306 provides a quick view of the relative strengths of the subject as compared to the group. For example, in comparing the layout of the group range plot 1310 with the demonstrated proficiency plot 1213, it can be seen that the subject scored better than most in business acumen, and worse than most in communication and data analysis. In comparing the demonstrated proficiency plot 1312 against the desired proficiency plot 1308, it is evident that the subject has a deficiency in communication and data analysis.

Beneath the proficiency distribution graph analysis area 1302, the feedback area 1304 contains comments directed toward the subject. These comments, in one example, may have been prepared by the manager, group leader, or person in another leadership role upon review of the competency assessment proficiency level scoring results and of the day-to-day performance of the individual. In another example, the feedback area 1304 can contain a compilation of feedback observations written by one or more assessors during the competency assessment process. The feedback comments entered within the feedback area 1304 include both praise for outstanding performance or behavior and suggestions for areas of improvement. In some implementations, the feedback comments are automatically compiled and added to the feedback area 1304 of the personal development report 1300. In other implementations, a user (e.g., direct supervisor, member of the career development group within the organization, etc.) manually adjusts each personal development report to address the key strengths and issues relating to individual subjects through adding in personalized feedback.

### Phase III: Design and Planning

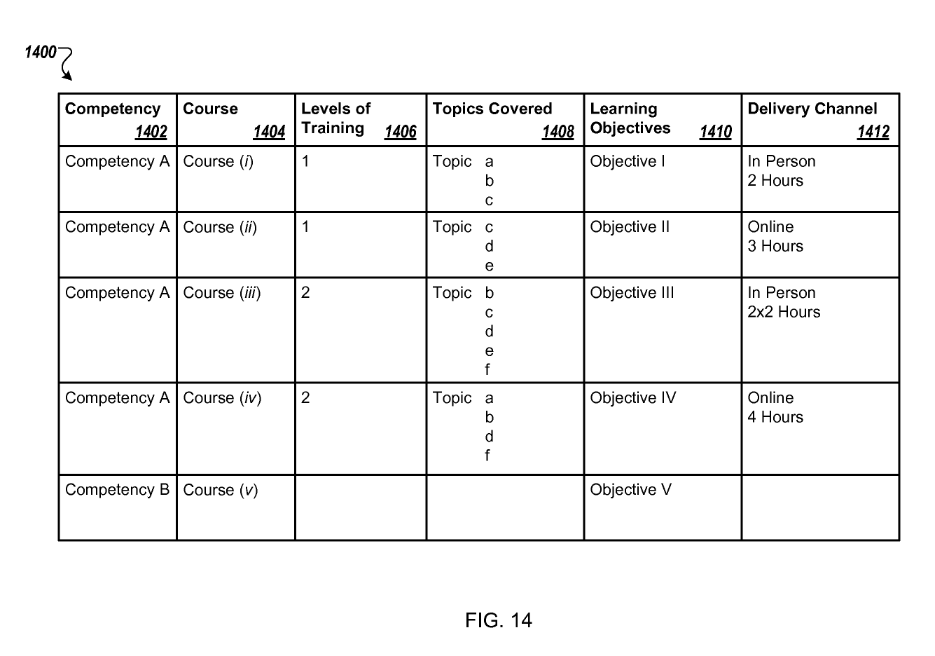

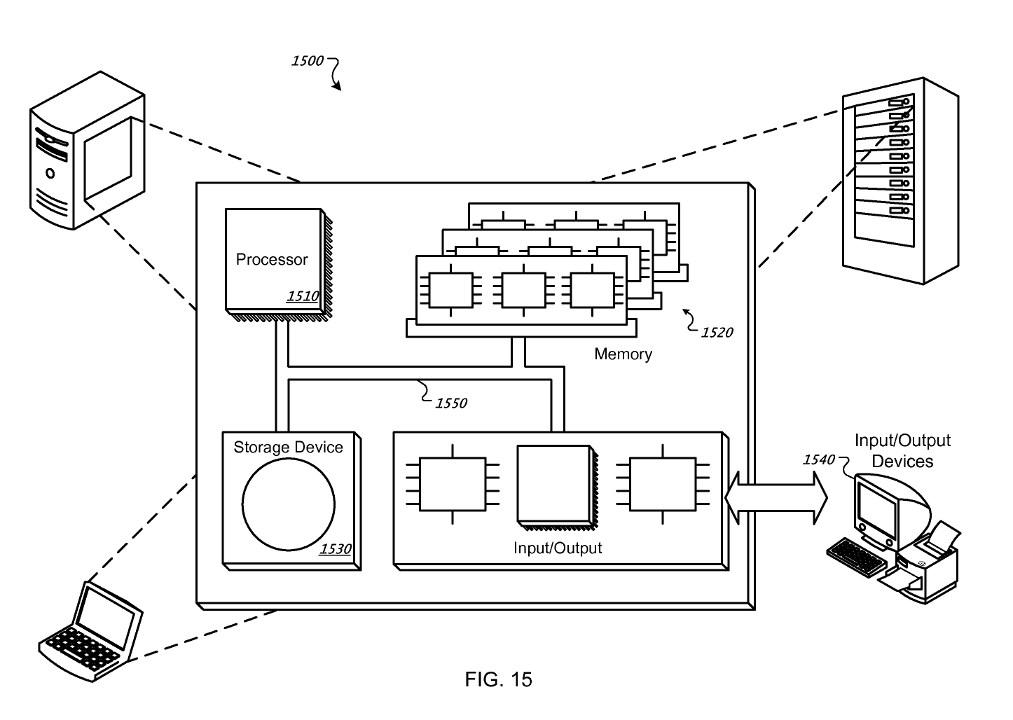

FIG. 14 is a table 1400 illustrating an example course outline. The course outline, for example, may have been generated by the system 100, as described in FIG. 1, based upon proficiency level deficiencies uncovered during a competency assessment process. For example, the plan generator 230 module of the capability accelerator application 210, as described in relation to FIG. 2, may have developed the course outline based upon course descriptions 248 available on the third party server 206. In other implementations, a training consultant, in tandem with a member of the organization, developed a customized course outline based upon the style and desires of the organization.

The table 1400 includes a competency column 1402 listing the name of the competency covered by the training, a course column 1404 providing a course identification, a levels of training column 1406 indicating a proficiency level associated with the course, a topics covered column 1408 listing an overview of the course coverage, a learning objectives column 1410 detailing a learning objective for the course, and a delivery channel column 1412 indicating the type and duration of the course.

The table 1400, for example, could be provided to the direct manager of a subject to validate the suggested training schedule. For example, the table 1400 can be presented through the management validation module 242, as described in relation to FIG. 2. In another example, the table 1400 could be provided to a scheduler module such as the scheduler 232 with in the capability accelerator application 210 or the scheduler 250, to schedule training courses for the subject. The scheduler 232 or the scheduler 250 could take into consideration the proposed course outlines for multiple subjects who participated in a competency assessment process to efficiently schedule training among a group of employees of an organization.

### Phases IV & V: Execution of Plan, Continuity, & Sustainability

Execution of the training, hiring, and promotional plans developed within phase III can be carried out by the organization. For example, participants can be notified of a training schedule, and ongoing training activities can be monitored through completion. Management can finalize decisions on promotional or hiring plans, in another example, based in part upon the recommendations provided through the competency assessment process.

Feedback regarding the various stages of the competency assessment process, in some implementations, can be collected and reviewed at this time. Based upon the feedback and results of the competency assessment process, one or more phases of the competency assessment process can be adjusted prior to future implementation. The adjusted process, for example, can be rolled out to additional groups or locations within the organization. As the organization grows and develops, the competency assessment process can continually adjust with the changing needs of the organization.

FIG. 15 is a schematic diagram of an exemplary computer system 1500. The system 1500 may be used for the operations described in association with the method 300 according to one implementation. For example, the system 1500 may be included in any or all of the server 102 (as shown in FIG. 1), the server 202, the client device 204, or the third party server 206 (as shown in FIG. 2).

The system 1500 includes a processor 1510, a memory 1520, a storage device 1530, and an input/output device 1540. Each of the components 1510, 1520, 1530, and 1540 are interconnected using a system bus 1550. The processor 1510 is capable of processing instructions for execution within the system 1500. In one implementation, the processor 1510 is a single-threaded processor. In another implementation, the processor 1510 is a multi-threaded processor. The processor 1510 is capable of processing instructions stored in the memory 1520 or on the storage device 1530 to display graphical information for a user interface on the input/output device 1540.

The memory 1520 stores information within the system 1500. In one implementation, the memory 1520 is a computer-readable medium. In one implementation, the memory 1520 is a volatile memory unit. In another implementation, the memory 1520 is a non-volatile memory unit.

The storage device 1530 is capable of providing mass storage for the system 1500. In one implementation, the storage device 1530 is a computer-readable medium. In various different implementations, the storage device 1530 may be a floppy disk device, a hard disk device, an optical disk device, or a tape device.

The input/output device 1540 provides input/output operations for the system 1500. In one implementation, the input/output device 1540 includes a keyboard and/or pointing device. In another implementation, the input/output device 1540 includes a display unit for displaying graphical user interfaces.

The features described may be implemented in digital electronic circuitry, or in computer hardware, firmware, software, or in combinations of them. The apparatus may be implemented in a computer program product tangibly embodied in an information carrier, e.g., in a machine-readable storage device for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations have been described. Nevertheless, it will be understood that various modifications may be made without departing from the scope of the disclosure. Accordingly, other implementations are within the scope of the following claims.

What is claimed is:

1. A computer-implemented method comprising:
generating a competency mapping for an organization, the competency mapping identifying one or more competencies required to perform a role in the organization and, for each competency, a desired proficiency level selected from among multiple proficiency levels defined for the competency;
performing a competency assessment on a subject, the competency assessment assessing the subject's actual proficiency level for each competency; and
generating, by one or more processors, a gap report using the competency mapping and the competency assessment, the gap report identifying, for each competency, any discrepancy between the desired proficiency level and the subject's actual respective proficiency level.

2. The method of claim 1, further comprising:
generating a plan for reducing or eliminating the discrepancy based on the gap report; and
implementing the plan.

3. The method of claim 2, wherein implementing the plan further comprises:
generating a message to inform the subject of an employment or training action which resulted based on the discrepancy.

4. The method of claim 2, wherein:
generating the plan further comprises:
accessing a catalog of training courses, and
selecting a training course which is designed to address the discrepancy; and
implementing the plan further comprises:
scheduling the subject to attend the training course.

5. The method of claim 2, wherein:
generating the plan further comprises preparing a hiring or promotion recommendation, or generating a succession plan.

6. The method of claim 2, further comprising:
responsive to executing the plan, performing a competency re-assessment on the subject.

7. The method of claim 1, wherein generating the competency mapping further comprises:
accessing a database of competency mappings that have been previously generated for other organizations;
receiving a user-input identification of one or more attributes of the organization;
determining a similarity between the organization and one or more of the other organization based on comparing the attributes with stored attributes for the other organizations; and
selecting, as the competency mapping, one of the competency mappings based on the similarity between the organization and the one or more other organizations.

8. The method of claim 7, wherein the attributes specify a type, size, or level of maturity of the organization.

9. The method of claim 1, wherein:
the role comprises prescribed or expected behaviors associated with a particular position or status in the organization; and
each proficiency level specifies an extent to which the subject exhibits a respective competence.

10. The method of claim 1, wherein the multiple proficiency levels defined for the competency comprise an awareness proficiency level, a functioning proficiency level, a skilled proficiency level, and an expert proficiency level.

11. The method of claim 1, further comprising:
defining the role;
defining each competency; and
defining the multiple proficiency levels for each competency.

12. The method of claim 11, wherein defining each competency further comprises:
defining a competency name and a process indicator that best exhibits application of the competency in practice.

13. The method of claim 1, further comprising:
generating a visualization of the competency mapping and the competency assessment.

14. The method of claim 13, wherein the visualization of the competency assessment provides the subject's actual proficiency level for each competency, and the proficiency levels for each competency as assessed for other members of the organization.

15. The method of claim 1, wherein performing the competency assessment on the subject further comprises conducting an interview of the subject, testing the subject using a psychometric test, conducting a group discussion with the subject, role playing with the subject, or performing an on-line testing exercise with the subject.

16. The method of claim 1, wherein the gap report identifies competency gaps for the subject and for the organization.

17. The method of claim 1, further comprising:
generating an assessment results validation interface for allowing a manager of the subject to validate results of the competency assessment or to order re-assessment.

18. The method of claim 1, wherein the organization comprises a human resources department.

19. A system comprising:
one or more computers; and
a computer-readable medium coupled to the one or more computers having instructions stored thereon which, when executed by the one or more computers, cause the one or more computers to perform operations comprising:
generating a competency mapping for an organization, the competency mapping identifying one or more competencies required to perform a role in the organization and, for each competency, a desired proficiency level selected from among multiple proficiency levels defined for the competency,
performing a competency assessment on a subject, the competency assessment assessing the subject's actual proficiency level for each competency, and
generating, by one or more processors, a gap report using the competency mapping and the competency assessment, the gap report identifying, for each competency, any discrepancy between the desired proficiency level and the subject's actual respective proficiency level.

20. A computer storage medium encoded with a computer program, the program comprising instructions that when executed by data processing apparatus cause the data processing apparatus to perform operations comprising:
generating a competency mapping for an organization, the competency mapping identifying one or more competencies required to perform a role in the organization and, for each competency, a desired proficiency level selected from among multiple proficiency levels defined for the competency;
performing a competency assessment on a subject, the competency assessment assessing the subject's actual proficiency level for each competency; and
generating, by one or more processors, a gap report using the competency mapping and the competency assessment, the gap report identifying, for each competency, any discrepancy between the desired proficiency level and the subject's actual respective proficiency level.
